(19) United States
(12) Patent Application Publication
(10) Pub. No.: US 2005/0137883 A1
(43) Pub. Date: Jun. 23, 2005

(54) Business form issuing apparatus and electronic business form system

(76) Inventors: Hiroaki Nohgawa, Osaka (JP); Nobuyoshi Hisao, Osaka (JP); Kiyotaka Shimoide, Funabashi-shi (JP)

Correspondence Address: SMITH, GAMBRELL & RUSSELL, LLP, 1850 M STREET, N.W., SUITE 800, WASHINGTON, DC, 20036, US

(21) Appl. No.: 10/738,993

(22) Filed: Dec. 19, 2003

(51) Int. Cl. G06F 17/60

(52) U.S. Cl. 705/1

(57) ABSTRACT

An business form issuing apparatus which is provided with a business form style data storing section which stores business form style data having a business form part arranging area being set therein, a business form part storing section which stores parts of business forms of a plurality of kinds, business form part reading section which reads out some of the part of business forms in accordance with user data, and a business form data generation processing section which generates business form data that has the part of business form being associated with the business form part arranging area of the business form style data.

### BACKGROUND OF THE INVENTION

1. Field of the Invention

The present invention relates to a business form issuing apparatus and an electronic business form system for issuing various business forms (vouchers) such as receipt, bill, inventory managing chart, proposal of insurance program, ticket and other negotiable papers.

2. Description of Related Art

An electronic business form system has been proposed which employs a server placed on the Internet and personal computers (clients) connected to the Internet (see, for example, Japanese Published Unexamined Patent Application (Kokai) No. 2002-163596). The server holds fixed business form style data accumulated therein such as complicated background image, ruled lines, characters and image. The personal computers send to the server such information that is used to identify user data which should be imported into fields that are set on the business form system data. In the server, image data of business form is generated by importing and overlaying the user data in the fields of the business form style. The image data of the business form is sent via the Internet to the personal computers. Users of the personal computers can obtain desired business forms by printing the received image data of business form with a printer.

In the prior art described above, however, various problems are encountered in actual operation, such as large storage capacity requirement for storing the business form style data and difficulty in issuing variety of business forms.

### SUMMARY OF THE INVENTION

An object of the present invention is to provide a business form issuing apparatus and an electronic business form system having practical constitutions.

A specific object of the present invention is to provide a business form issuing apparatus which enables it to issue business forms having variety of appearances without causing significant increase in the storage capacity, and an electronic business form system which employs the business form generating apparatus.

Another specific object of the present invention is to provide a business form issuing apparatus which can reduce the memory requirement for business form styles and make it easier to manage business form styles of a plurality of kinds, and an electronic business form system which employs the business form generating apparatus.

Further another specific object of the present invention is to provide a business form issuing apparatus which can assuredly prevent an illegal output of a business form and an electronic business form system which employs the business form generating apparatus.

Further specific object of the present invention is to provide a business form issuing apparatus and an electronic business form system which are capable of recording a log relating to business form outputs, thereby making it easy to trace troubles in business form output or illegal output of business form.

Aforementioned and other objects, features and effects of the invention will become apparent through the description of preferred embodiments that follows with reference to accompanying drawings.

### BRIEF DESCRIPTION OF THE DRAWINGS

FIG. 1 is a block diagram showing the overall constitution of an electronic voucher system according to one embodiment of the present invention.

FIG. 2 is a block diagram showing the electrical constitution of a server.

FIG. 3 is a block diagram explanatory of files stored in a storage device of the server.

FIG. 4 is a block diagram explanatory of the functional constitution of the server.

FIG. 5 is a block diagram showing an example of the electrical constitution of a client.

FIG. 6 is a block diagram explanatory of the functional constitution of the client.

FIG. 7 is a block diagram explanatory of the schematic constitution of an electronic voucher system comprising the server and the client.

FIG. 8 shows an example, as displayed by Web browser, of an acceptance screen that receives the entry of voucher data request.

FIG. 9 shows an example of XML file generated as voucher generating information file by a request data analyzing section.

FIG. 10 is a flow chart explanatory of the operation of data collection and combination processing means that have received the voucher generating information file and a user data file.

FIG. 11 is a flow chart explanatory of the operation of an XML application.

FIG. 12 is a schematic diagram explanatory of an XRT file, which is one of major components of the XRF file.

FIG. 13 is a block diagram explanatory of the constitution of the XRT file.

FIGS. 14(a), 14(b) and 14(c) show specific examples of the constitution of the XRT file.

FIG. 15 is a block diagram explanatory of the constitution of the XRF file.

FIG. 16 is a flow chart illustrative of a process in which a voucher image is generated in accordance to the XRF file.

FIG. 17 is a schematic diagram explanatory of a typical aspect of using a part XRT file.

FIG. 18 shows an example of the display of XRF reader which has received an XRF file.

FIG. 19 is a schematic diagram explanatory of an example of editing a part XRT file.

FIG. 20 is a schematic diagram explanatory of the effect of using the part XRT file.

FIG. 21 is a block diagram explanatory of an example of the server constitution which has a function to change the appearance of voucher according to user data.

FIG. 22 is a schematic diagram explanatory of the selection of image file in accordance to user data.

FIG. 23 is a schematic diagram explanatory of an example of voucher data (XRF file) supplied from the server to a client.

FIG. 24 is a block diagram explanatory of another example of the server constitution used to change the appearance of voucher according to user data.

FIG. 25 shows an example of display by property editing dialog box for a drawing object corresponding to a rectangular graphic figure.

FIG. 26 is a schematic diagram explanatory of deformation of a rectangular graphic figure due to a change in the property of the drawing object in accordance to the value of user data.

FIG. 27 is a schematic diagram explanatory of an example of voucher data supplied from the server to a client.

FIG. 28 is a block diagram explanatory of the constitution of an electronic voucher system which achieves a function to change the property of drawing object according to user data.

FIG. 29 is a block diagram showing the overall constitution of an electronic voucher system according to another embodiment of the present invention.

FIG. 30 is a block diagram explanatory of an example of the constitution of the server according to this embodiment.

FIG. 31 is a block diagram explanatory of an example of the constitution of clients in the electronic voucher system of this embodiment.

FIG. 32 is a block diagram explanatory of operation of the electronic voucher system constituted from the server shown in FIG. 30 and the clients shown in FIG. 31.

FIG. 33 is a block diagram explanatory of another example of the constitution of the server used in the electronic voucher system of the constitution shown in FIG. 29.

FIG. 34 is a block diagram explanatory of the constitution of the electronic voucher system constituted from the server shown in FIG. 33 and the clients shown in FIG. 31.

FIG. 35 is a block diagram explanatory of an example of the constitution of a server according to further another embodiment of the invention.

FIG. 36 is a block diagram explanatory of an example of the constitution of a client according to the embodiment shown in FIG. 35.

FIG. 37 is a block diagram explanatory of schematic constitution of the electronic voucher system constituted from the server shown in FIG. 35 and the clients shown in FIG. 36.

FIG. 38 shows an example, as displayed by Web browser, of an acceptance screen that accepts the entry of setting for permission to send voucher data.

FIGS. 39(a), 39(b) and 39(c) show examples, as displayed by web browser, of an acceptance screen (menu screen) that accepts the entry of voucher data request.

FIG. 40 is a flow chart explanatory of the operation of controlling the client.

### DESCRIPTION OF THE PREFERRED EMBODIMENTS

Contents

1. Overall constitution of electronic voucher system
2. Constitution of server
   2-1. Hardware constitution of server
   2-2. Files and the like used for generating voucher data
   2-3. Functional constitution of server
3. Constitution of client
   3-1. Hardware constitution of client
   3-2. Functional constitution of client
4. Operation of entire electronic voucher system
5. Description of voucher data file (XRF file)
6. Generation of voucher image
7. Mode of using part XRT file
8. Operation of XRF reader
9. Generation of part XRT file
10. Alteration of appearance according to user data
   10-1. Selection of image parts according to user data
   10-2. Alteration of property of drawing object according to user data
11. Embodiment capable of cashing the component files of voucher form.
12. Alteration of property of drawing object at client
13. Embodiment capable of certifying users.
14. Other embodiments
   1. Overall Constitution of Electronic Voucher System

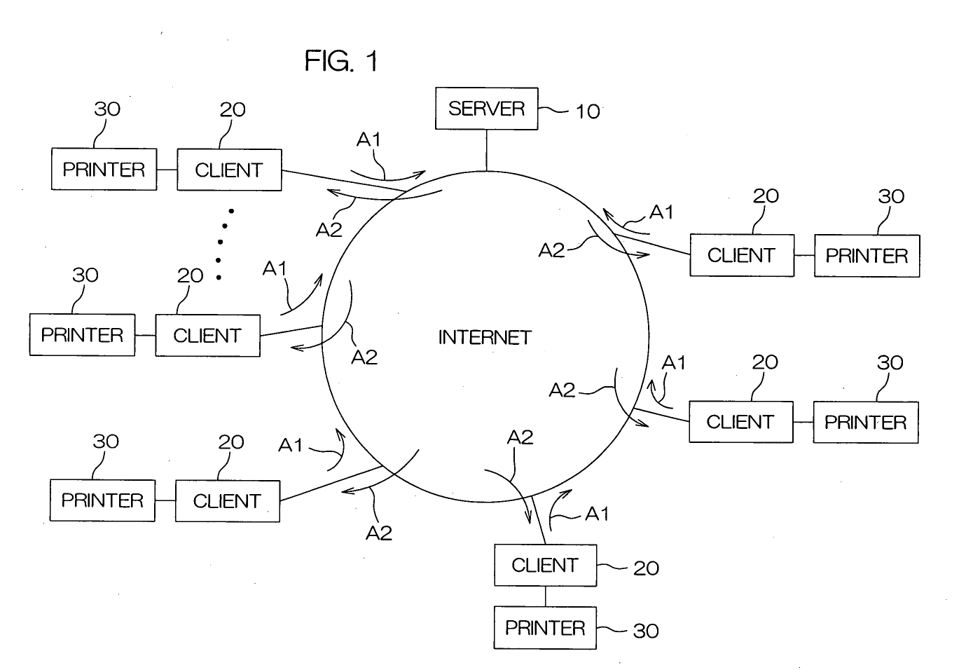

FIG. 1 is a block diagram showing the overall constitution of an electronic voucher system according to one embodiment of the present invention. The term “voucher” should be understood hereinafter to mean a business form including a receipt, inventory, control chart, proposal of insurance program, ticket and other negotiable papers.

The electronic voucher system is such a system that is designed to carry out comprehensive management of vouchers used in business operations (those used within the company and those issued to customers or business traders) in a company or other business organization that has many offices (branches and business offices) at different locations.

The voucher system includes a server 10 connected to a network such as the Internet, an intranet of a company, LAN (local area network) or WAN (wide area network) (a case of the Internet will hereafter be described as a typical example, but the description applies similarly to other forms of network), and a plurality of clients 20 connected to the Internet. The server 10 is a computer which is capable of processing a large volume of data and is connected to the Internet so as to carry out communications. The clients 20 are personal computers which are installed at the offices and are connected to the Internet so as to carry out communications. With this constitution, the server 10 and the clients 20 can transmit and receive data to and from each other via the Internet. A printer 30 is connected to the client 20 for printing vouchers. The client 20 and the printer 30 may be either connected to each other via a printer cable or connected via a local area network so that the printer 30 can be shared by a plurality of clients 20 that are connected to the local area network.

In the case of an insurance company, for example, it is said that 2000 to 3000 kinds of voucher are required to carry out business operations. It requires considerable labor to manage the vouchers individually and use unified forms among the offices. For this reason, in the electronic voucher system, the server 10 manages all the voucher forms and supplies voucher data upon request from the clients 20.

When a voucher is required at an office, the user can operate the client 20 so as to send a voucher data request that specifies the kind of voucher required and items to be entered therein to the server 10 via the Internet (arrow A1). According to the voucher data request sent from the client 20, the server 10 generates voucher data for the voucher required by the user and sends the data to the client 20 via the Internet (arrow A2). Upon receipt of the voucher data, the client 20 develops the voucher data into print data so that it can be printed on the printer 30. Thus the user obtains the required voucher.

The electronic voucher system releases the offices from the labor of managing (updating, etc.) the voucher and enables it to easily prepare the required voucher by using the clients 20 installed therein. Moreover, since use of the vouchers throughout the company can be monitored in detail by accessing the server 10 from the clients 20, it is also made possible to monitor the business operations of the entire company such as sales and finance by using the clients 20.

2. Constitution of Server

2-1. Hardware Constitution of Server

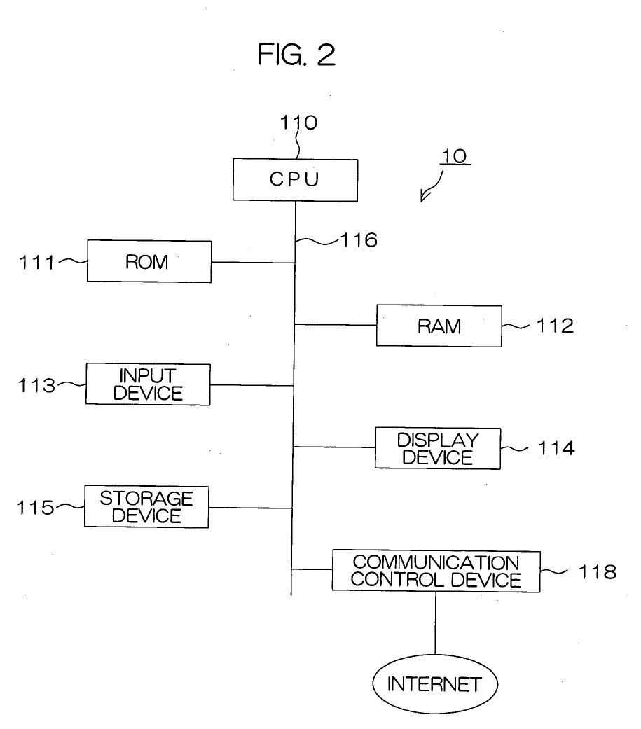

FIG. 2 is a block diagram showing the electrical constitution of the server 10. The server 10 is provided with a CPU 110, ROM 111, RAM 112, an input device 113, a display device 114, a storage device 115 and a communications control device 118, which are connected with each other via a bus 116. The CPU 110 controls the exchange of data among the ROM 111, the RAM 112, the input device 113, the display device 114, and the storage device 115, and controls the operations of the input device 113, the display device 114, the storage device 115 and the communications control device 118 according to programs stored in the ROM 111, while controlling the connection with the Internet via the communications control device 118.

Since the server 10 may carry out a complicated operation involving a large volume of data, it is desirable to use the CPU 110 having high performance. Such a constitution that uses an MPU (microprocessor unit) instead of the CPU 110 may also be employed.

The input device 113 may include a keyboard, a pointing device, etc., of which operating signals are sent to the CPU 110. The display device 114 may be a CRT, liquid crystal display panel or the like that is capable of 2-dimensional display, and displays images in accordance with the display signals sent from the CPU 110.

The storage device 115 may include a hard disk drive or the like and is used as a storage medium to store data and application programs required by the server 10. The CPU 110 is capable of storing data on the storage device 115 and read data stored on the storage device 115 so as to use the data as required.

2-2. Files and the Like Used for Generating Voucher Data

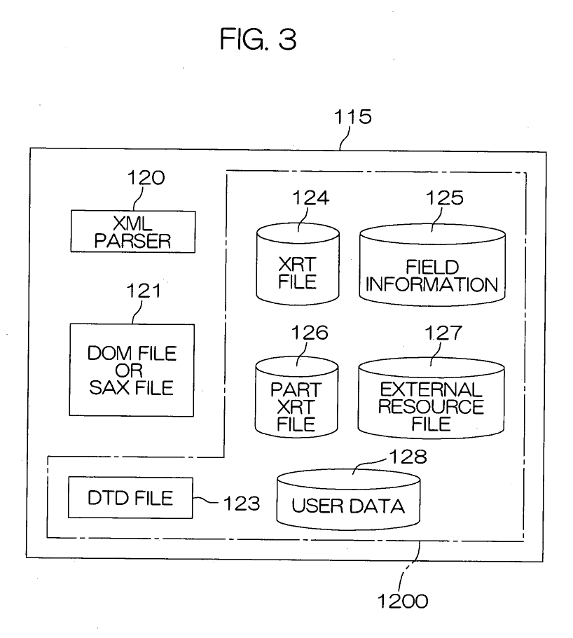

FIG. 3 is a block diagram explanatory of the files stored on the storage device 115. The storage device 115 stores an XML parser 120 which analyzes XML (Extensible Markup Language) file, a DOM (Document Object Model) file or an SAX (Simple API for XML) file 121 that controls the exchange of data between the XML file and an XML application. XML application program that runs on the server 10 is also stored on the storage device 115 so as to be read and executed by the CPU 110, but illustration thereof is omitted in FIG. 3.

The storage device 115 also stores a user database 128 which holds and manages user data consisting of personal data related to customers, etc., XRT files 124 each of which is a file of original format that defines fixed image portions (background, layout, image, drawing object, text, barcode, etc.) of voucher forms (business form styles), part XRT files 126 each of which is a file of original format that defines a similar fixed image portion which can be incorporated by specifying an area in voucher forms, external resource files 127 (image data) each of which can be incorporated in the voucher forms, field information 125 which represents the number, order, data type, etc. of fields set in an XRT file or in a part XRT file, and DTD (Document Type Definition) files each of which matches the field and the user data. These files are components of an XRF file which is a voucher data file.

The XRF file, which has an original format, is not image data (such as bitmap data or PDF file) generated by synthesizing a voucher form and user data, but is a file that contains all the component data which constitute the voucher. Based on the XRF file, image data for display and printing are generated by synthesizing the voucher form and the user data in the client 20. Consequently, since the voucher data is sent in the XRF file format from the server 10 to the client 20 in the electronic voucher system, file size can be made far smaller than in the case of sending the voucher data in the form of image data, and the file size can be made even smaller by compressing the data. This makes it possible to reduce the traffic on the network.

The XRT file 124, field information 125, part XRT file 126 and external resource file 127, generated in advance by using a drawing application or the like, are stored on the storage device 115, each in a plurality of types. User data 128 is also stored on the storage device 115 beforehand. The XRT file 124 and the field information 125 are stored in one-to-one correspondence to each other. The external resource file 127 is an image data file generated by optically reading graphics and/or photographs with scanner or the like. The part XRT file 126 is another XRT file that constitutes an area to be embedded in the XRT file, and consists of components which can be arranged in the XRT file. The part XRT file 126 is shared and used by a plurality of XRT files (voucher forms) and constitutes a part of each of the plurality of voucher forms in which registered is an area the part XRT file is embedded. It is also possible to specify an area in a part XRT file and embed another part XRT file in the area.

The DTD file 123, the XRT file 124, the field information 125, the part XRT file 126, the external resource file 127 and the user data 128 may be called the component parts of the XRF file as voucher data file, while these files or data groups are stored in a predetermined storing area of the storage device 115, so as to constitute the part server 1200. Among the components of the XRF file, those other than the user data 128 are components of the voucher form.

2-3. Functional Constitution of Server

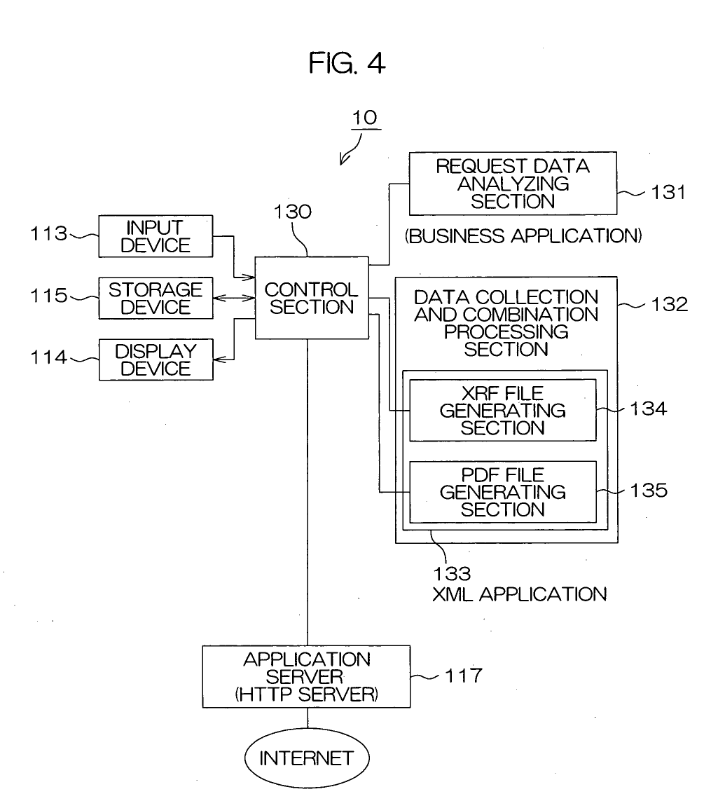

FIG. 4 is a block diagram explanatory of the functional constitution of the server 10. The server 10 is substantially provided with a plurality of functional processing units which are realized as the CPU 110 executes a program stored on the ROM 111 or the storage device 115. More specifically, the server 10 has a control section 130 and an application server 117 which is controlled by the control section 130. The application server 117 is realized by an application program that controls the communication between the serer 10 and the clients 20, and has a function to receive requests from users and submit them to the business operation system, and a function as a Web server (HTTP server).

The application server 117 has files (not shown) which are written in HTML (Hyper Text Markup Language) or the like. These files are sent from the application server 117 to the client 20 when connection between the server 10 and the client 20 via the Internet is established. The application server 117 is constituted so as to be capable of receiving voucher data request which is sent by the client 20 in response to the files described above. The voucher data request which has been received is sent to the control section 130.

The server 10 is further provided with a request data analyzing section 131 and a data collection and combination processing section 132 which are controlled by the control section 130. The request data analyzing section 131 is a function processing section realized by a business application which is installed in the server 10 and executes business logic, that analyzes the voucher data request (which includes the type of voucher and information for specifying user data) which is supplied from the client 20, so as to specify the DTD file 123, XRT file 124, field information 125, part XRT file 126, external resource file 127 and the user data 128 which are parts (component data) of the voucher data file (XRF file) that corresponds to the voucher data request. The request data analyzing section 131 automatically generates voucher generating information file which is an XML file, written in XML, that comprises the information (including parameters and commands) used to generate the voucher data corresponding to the voucher data request.

The voucher generating information file also includes the parts of voucher data files (the DTD file 123, XRT file 124, field information 125, part XRT file 126, external resource file 127 and the user data 128) which are identified through the analysis of the voucher data request. The request data analyzing section 131 can convert the user data, which is identified by the information included in the voucher data request, into user data file of the format of XML file or CSV (Comma Separated Value) file.

The data collection and combination processing section 132 includes an XML application 133. The XML application 133 is Java™, for example, which is an application program capable of interpreting the contents of an XML file and executing it, and is installed in the server 10 in advance so as to be executable. Consequently, when voucher generating information file which is an XML file is given to the data collection and combination processing section 132, the XML application 133 interprets and executes it.

The XML application 133 has an XRF file generating section 134 that generates an XRF file as one format of voucher data file according to the voucher generating information file generated by the request data analyzing section 131, and a PDF (Portable Document Format) file generating section 135 which generates a PDF file as another format of the voucher data file.

The XRF file generating section 134 makes reference to the file information about the voucher data file parts (DTD file 123, XRT file 124, field information 125, part XRT file 126, external resource file 127 and user data 128) included in the voucher generating information file generated by the request data analyzing section 131, so as to read these files from the parts server 1200 stored in the storage device 115. Then the XRF file generating section 134 combines the files that have been read and generates an XRF file as the voucher data file. The data collection and combination processing section 132 further submits the XRF file to the application server 117.

The PDF file generating section 135 makes reference to the file information about the voucher data file parts (DTD file 123, XRT file 124, field information 125, part XRT file 126, external resource file 127 and user data 128) included in the voucher generating information file generated by the request data analyzing section 131, so as to read these files from the parts server 1200 stored in the storage device 115. Then the PDF file generating section 135 combines the files that have been read and develops the combined file into image data so as to generate a PDF file and submits it to the application server 117.

Thus when the voucher data request is given to the server 10, the request data analyzing section 131 generates a voucher generating information file, written in XML, that comprises the information (including parameters and commands) used to generate the voucher data corresponding to the voucher data request. As the XML application 133 interprets and executes the voucher generating information file, the voucher data file in XRF or PDF format is generated. Then, the voucher date file in XRF or PDF format is sent from the application server 117 to the client 20.

3. Constitution of Client

3-1. Hardware Constitution of Client

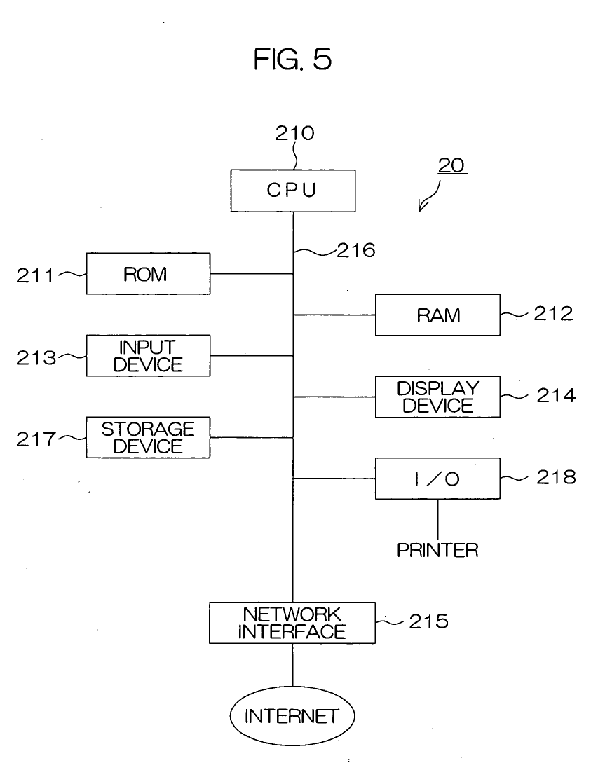

FIG. 5 is a block diagram showing an example of electrical constitution of the client 20. The client 20 has a CPU 210, ROM 211, RAM 212, an input device 213, a display device 214, a storage device 217 (such as hard disk drive), a network interface 215 and an input/output interface (I/O) 218, which are connected with each other via a bus 216. The CPU 210 controls the exchange of data among the ROM 211, the RAM 212, the input device 213, the display device 214, the network interface 215 and the input/output interface 218, and controls the operations of the input device 213, the display device 214 and the network interface 215 according to programs stored in the ROM 211 and in the storage device 217.

The input device 213 may include a keyboard, a pointing device, etc., of which operating signals are sent to the CPU 210. The display device 214 is a 2-dimensional image display device such as CRT, liquid crystal display panel or the like, and displays images in accordance with the display signals sent from the CPU 210.

The CPU 210 is connected to the Internet via the network interface 215. Consequently, the CPU 210 can send voucher data request via the Internet to the server 10.

A printer 30 may be connected to the client 20 via the input/output interface 218 and print data may be sent to the printer 30. In the case that the client 20 and the printer 30 are connected with each other via a local area network, a network adaptor may be used as the input/output interface 218 for connecting the printer.

3-2. Functional Constitution of Client

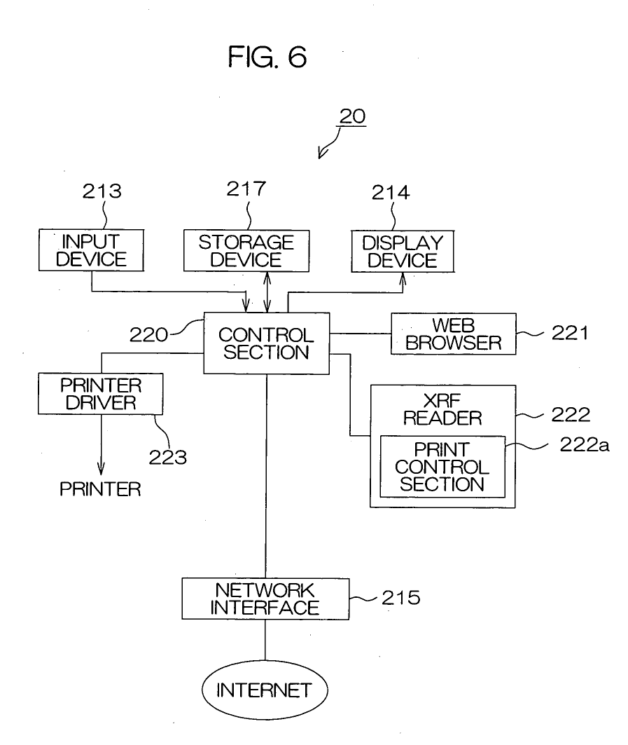

FIG. 6 is a block diagram explanatory of the functional constitution of the client 20. The client 20 is substantially provided with a plurality of functional processing units which are realized as the CPU 210 executes programs stored on the ROM 211 or the storage device 217. More specifically, the client 20 has a control section 220 that controls the network interface 215. The control section 220 controls the network interface 215 so as to receive a file sent from the server 10 via the Internet.

The client 20 is further provided with a Web browser 221, an XRF reader 222 and a printer driver 223, which are controlled by the control section 220.

The Web browser 221 is a commercially available application program for viewing Web pages such as Internet Explorer™, which is installed in the client 20 in advance so as to be executable. When the Web browser 221 is initiated, a screen for viewing files of HTML format or the like is displayed on the display device 214. The Web browser 221 receives files of HTML format or the like from various servers (including the server 10) connected to the Internet and displays the file in a display window of the Web browser 221. When the display window of the Web browser 221 is active and the input device 213 is operated by a user, the operating information is sent to the Web browser 221. The information that has been input is displayed in the Web browser 221, and is transmitted to the server which supplied the HTML file or the like upon a predetermined input operation.

The Web browser 221 can also receive PDF files from servers (including the server 10) connected to the Internet, so as to display a file of PDF format, that has been received, in the Web browser 221. More specifically, when the Web browser 221 receives a PDF file, a PDF file viewing program (Acrobat Reader™) which is an add-in software, is started (internally started within the window of the Web browser 221).

When the PDF file is being displayed by the Web browser 221 and a user makes a predetermined operation on the input device 213, a print setting dialog box of the printer driver 223 opens. As printing conditions are set in the print setting dialog box, the file of PDF format is converted into print data which is handed over to the printer driver 223, so that the PDF file is printed as the print data is sent from the printer driver 223 to the printer 30.

A user can also specify URL (Uniform Resource Locator) on the Web browser 221 by operating the input device 213. URL is a piece of information that identifies the location (on the Internet) of a server that provides files written in HTML or the like and/or files of PDF format. The Web browser 221 can receive files written in HTML or the like and files of PDF format from a server of the specified URL. When the electronic voucher system of this embodiment is used, URL of the server 10 is entered in the URL input box of the Web browser 221.

The XRF reader 222 is an application program capable of displaying the XRF files which are sent from the server 10, and is installed in the server 10 in advance ready to be executed. In the case that the XRF reader 222 is set as a helper application for the Web browser 221, the XRF reader 222 can be automatically started (externally started in a window other than the Web browser 221) when the Web browser 221 receives an XRF file. When the XRF reader 222 is started, an XRF file viewing screen is displayed on the display device 214. If a user makes a predetermined input operation on the input device 213 when the XRF file is being displayed on the viewing screen, an image file for printing is generated from the XRF file and accordingly the image can be printed on the printer 30.

According to this embodiment, the XRF reader 222 has a built-in print control section 222a, and allows it to set the printing conditions in an original dialog box different from the setting screen of the printer driver 223 and accordingly control the operation of the printer 30. When printing, print data is submitted from the print control section 222a to the printer driver 223, and the image data is sent from the printer driver 223 to the printer 30.

The print control section 222a of the XRF reader 222 displays the print dialog box in response to a print command from a user. In this print dialog box, the user can set various conditions such as the number of printouts and the paper size, and thereafter command to start printing. When it is commanded to start printing, the print control section 222a closes the print dialog box and displays in-printing dialog box which shows that printing is currently in operation. The in-printing dialog box has a cancel button disposed therein to allow it to interrupt the printing. Printing operation can be canceled by operating the cancel button. When printing operation is completed (transmission of the print data to the printer 30 is completed), the print control section 222a closes the in-printing dialog box.

Since print paper size and other parameters are specified at the same time as the XRT file is generated so that the XRT files have the information on the printing conditions, setting of the printing conditions is not necessarily required.

The XRF file may be provided with various parameters that define the operations (screen displaying operation and printing operation) of the XRF reader 222 included therein. These parameters may include those indicative of permission or prohibition as to storing the XRF file, printing the data, displaying the image, displaying the print dialog box, displaying the in-printing dialog box, and so on at the client, as required. This enables it at the client 20 to restrict (prohibit) it to store the XRF file on the storage device 217, restrict (prohibit) it to print or display the XRF file, inactivate the display of the print dialog box, inactivate the display of the in-printing dialog box or the like.

The aforementioned features enable it to prevent illegal issuance of a voucher such as a receipt. That is, illegal issuance of a voucher through reuse of the XRF file can be prevented by prohibiting the storage of XRF file. It is also made possible to permit only particular persons to issue a voucher by prohibiting printing. When display of an image is prohibited, illegally copying voucher data by clipping the displayed image can be restricted. Moreover, inactivating the display of the printing dialog box enables it to prevent illegal outputs of a plurality of voucher. Further, inactivating the display of the in-printing dialog box enables it to prevent illegal use of an incomplete voucher when interruption of printing operation results in the output of the incomplete voucher.

4. Operation of Entire Electronic Voucher System

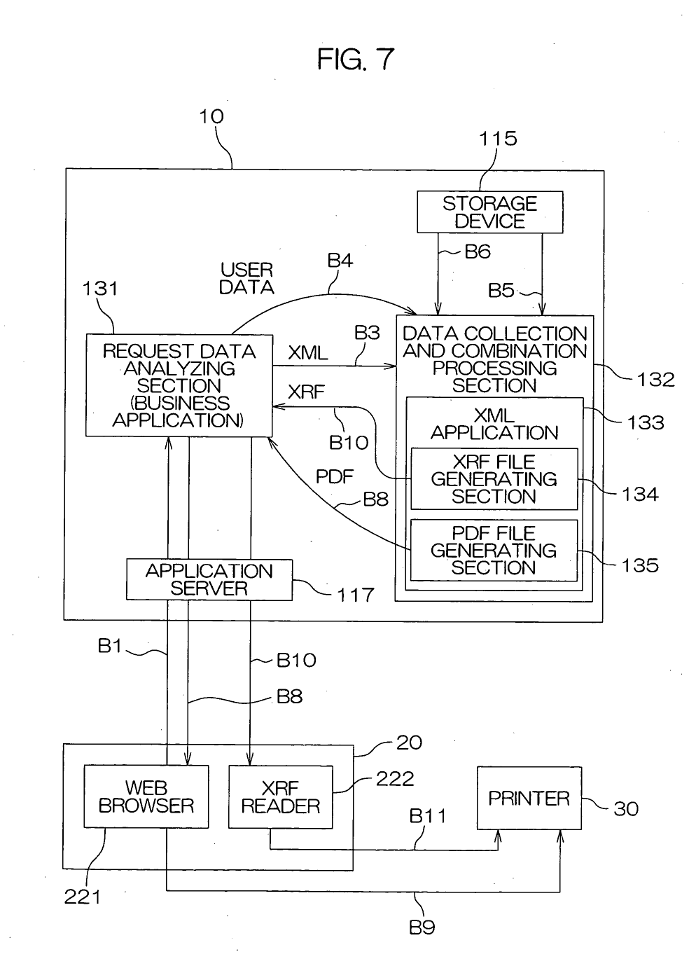

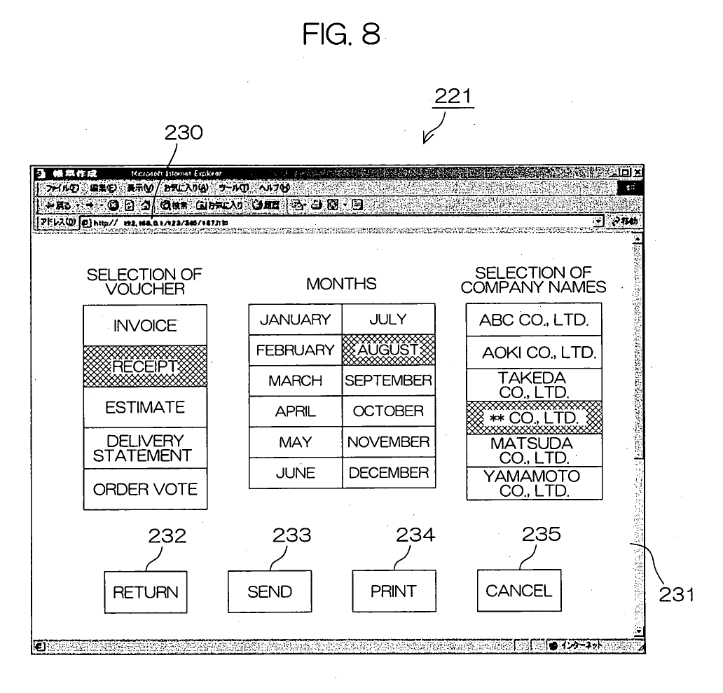

FIG. 7 is a block diagram explanatory of the schematic constitution of an electronic voucher system comprising the server 10 and the client 20. FIG. 8 shows an example, as displayed by the Web browser 221, of an acceptance screen that receives the entry of voucher data request.

When a user (sales personnel of an office or the like) requires a voucher, the user starts the Web browser 221 of the client 20 and specifies the URL of the server 10. Then the Web browser 221 receives a file written in HTML or the like from the application server 117 of the server 10 and displays such a screen as shown in FIG. 8. On this screen, the Web browser 221 can accept the input of a request for the voucher required by the user. When the input device 213 is operated so as to carry out a predetermined transmitting operation of the Web browser 221, a voucher data request corresponding to the input is sent by CGI or a Java applet to the application server 117.

The Web browser 221 has a URL input section 230 and a display section 231. When the URL of the server 10 is entered in the URL input section 230, the Web browser 221 receives a file written in HTML or the like from the server 10 and displays it on the display section 231.

In the example shown in FIG. 8, lists of voucher types, months and company names are displayed as the lists of options at the center of the display section 231. Displayed at the bottom of the display section 231 are a RETURN button 232, a SEND button 233, a PRINT button 234 and a CANCEL button 235.

The user can select the desired voucher parameters from the lists of voucher types, months and company names by operating the input device 213. In this example of display, “Receipt”, “August” and “xxx Co., Ltd.” are selected respectively, meaning “Receipt for transactions conducted in August with xxx Co., Ltd.”. Selected items are highlighted by different color, inversed display, or the like so as to differentiate them from other items not selected.

The Web browser 221 also displays a pointer (not shown) which is moved over the different buttons 232 through 235 by the user operating the input device 213 (mainly the pointing device), so that the buttons 232 to 235 can be pressed (clicked) When the RETURN button 232 is pressed, another HTML file or the like is read so that the display section 231 shows differently from that of this example. For example, an HTML file or the like that had been shown before this operation, or the menu screen of the electronic voucher system may be displayed.

When the PRINT button 234 is pressed, on the other hand, a voucher data request that includes the voucher parameters currently selected is sent to the server 10. When the CANCEL button 235 is pressed, the selected state of items on the display section 231 is cleared.

The SEND button 233 is operated when it is desired to continue the entry of the parameters of another voucher. When a user intends to generate a plurality of vouchers, for example, repeating the selection of the parameters of individual vouchers and pressing the PRINT button 234 results in an idle period from the time the printer 30 receives voucher data from the server 10 and outputs one voucher to the time when the printer 30 receives the print data of the next voucher. The printer 30 may receive print data other than voucher (for example, print data from another user who shares the printer 30 on the local area network) during the idle period. This results in such a situation as a sheet of paper with the other print data printed thereon is mixed in the vouchers output from the printer 30. Consequently, the user is forced to check every sheet of printouts from the printer 30 and remove sheets other than the intended voucher.

This problem can be avoided by using the SEND button 233. Specifically, when the SEND button 233 is pressed, the voucher data request that includes the voucher parameters currently selected is sent from the application server 117 of the server 10 to the request data analyzing section 131 and is stored in the RAM 112 or the storage device 115 in the server 10, so that the user can select other voucher parameters. As this operation is repeated the number of times as the number of required vouchers, the voucher data request that corresponds to the vouchers are stored in the server 10 in the same way. Then as the last voucher parameter is selected and the PRINT button 234 is pressed, the voucher data request that include the voucher parameters currently selected on the Web browser 221 are sent to the application server 117 and submitted to the request data analyzing section 131 so as to be stored in the RAM 112.

In the meantime, the request data analyzing section 131 executes an operation to combine the plurality of voucher data requests stored in the RAM 112 into one job and generate voucher data of a plurality of pages. This causes the data collection and combination processing section 132 and other units to generate voucher data that correspond to the plurality of voucher data requests (voucher data of a plurality of pages) which are sent from the application server 117 to the client 20. As a result, since the client 20 provides the printer 30 with the print data of a plurality of pages of voucher continuously, the aforementioned problem can be avoided.

Now making reference to FIG. 7 again, voucher data request that includes the specification of voucher parameters required by the user is sent from the client 20 to the server 10 (arrow B1). The voucher data request is received by the application server 117 and is submitted to the request data analyzing section 131. The request data analyzing section 131 generates an XML file (voucher generating information file) which gives the information required to generate voucher data for the voucher data request described in XML. The request data analyzing section 131 also reads, from the parts server 1200, particular user data that corresponds to the information specified by the user such as the voucher parameters included in the voucher data request, and converts the user data into XML file or CSV file, thereby to generate a user data file.

Usually, user data is stored on the server 10 side and particular user data identified by the parameters (such as the customer's name and date of birth, etc.) specified in the voucher data request that has been sent from the client 20 is read from the parts server 1200, but in some cases, numerical data that matches the parameters specified in the voucher data request is generated in the request data analyzing section 131 which is a business application, so that the numerical data is used as the user data.

The voucher generating information file generated by the request data analyzing section 131 is submitted to the data collection and combination processing section 132 (arrow B3). The user data file is also submitted to the data collection and combination processing section 132 (arrow B4).

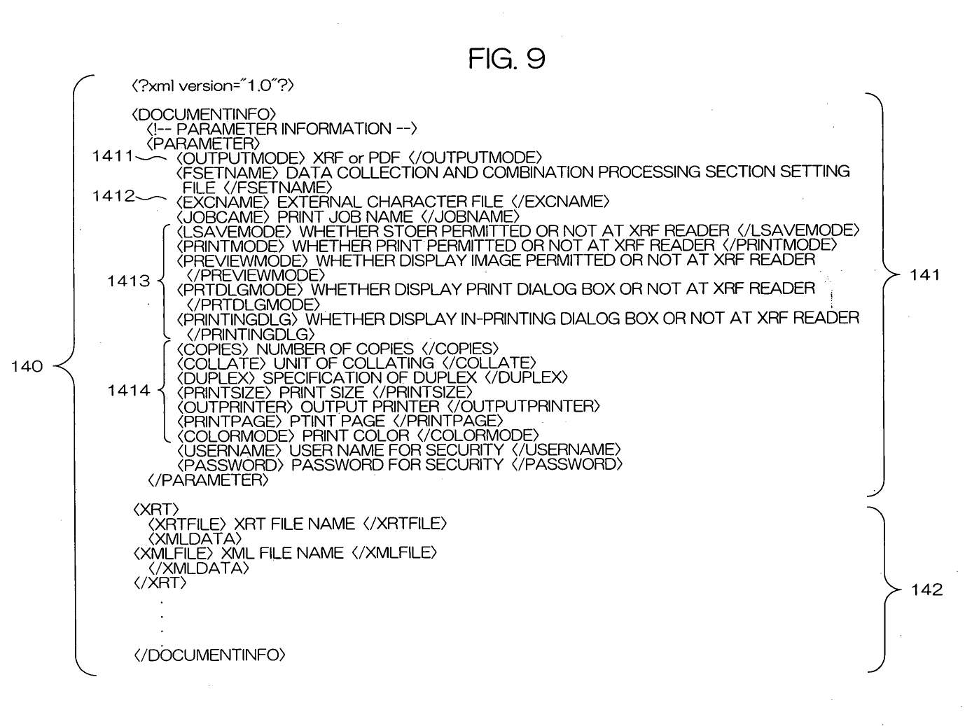

FIG. 9 shows an example of XML file generated as the voucher generating information file by the request data analyzing section 131. The voucher generating information file 140 consists of XML file and is written in text format. Therefore, administrator of the server 10 can easily understand the content of the voucher generating information file 140. As a result, the administrator of the server 10 can monitor the operations that are carried out in the server 10 so as to easily maintain and manage the server 10.

The voucher generating information file 140 is constituted from a condition setting descriptor section 141 that describes the parameters set for generating the voucher data, and an XRF file identifying information descriptor section 142 that describes the information required to identify the component data (the XRT file 124, the field information 125, the part XRT file 126, the external resource file 127, the DTD file 123 and the user data 128) of the XRF file, which are the voucher data that correspond to the voucher data request.

The condition setting descriptor section 141 includes an output file mode descriptor section 1411 where the output file mode is described so as to specify whether to output voucher data of XRF file format or voucher data of PDF file format from the server 10, an external character file information descriptor section 1412 where the type of characters used for the voucher data is described, an XRF reader operation setting descriptor section 1413 where settings (parameters) related to the operation of the XRF reader 222 at the client 20 are described, and a printer operation setting descriptor section 1414 where settings (parameters) related to the operation of the printer 30 are described.

As described above, the XRF file which is a voucher data file generated by the data collection and combination processing section 132 can include various parameters that define the operations (screen display operation and printing operation) of the XRF reader 222. These parameters are described in the XRF reader operation setting descriptor section 1413 of the voucher generating information file 140, and is embedded in the XRF file by the data collection and combination processing section 132.

As will be understood from the above description, although the voucher generating information file 140 does not include much information described therein, it allows it to set the operations of the entire electronic voucher system.

Also because the voucher generating information file 140 is an XML file, the administrator of the server 10 can easily modify the voucher generating information file 140. Therefore, in case a trouble occurs in the electronic voucher system, remedial action for the trouble can be quickly taken. Addition of a new operation to the electronic voucher system can also be done easily by editing the voucher generating information file 140.

Now referring to FIG. 7 again, upon receipt of the voucher generating information file (XML file) and user data file (XML file or CSV file), the data collection and combination processing section 132 starts the XML application 133 to run, by reading the XML parser 120, and the DOM file or the SAX file 121 from the storage device 115 (arrow B5).

When XRF file format is specified as the output file mode for voucher data (or PDF file format is not specified) in the output file mode descriptor section 1411 of the voucher generating information file 140, the XRF file generating section 134 of the XML application 133 interprets the voucher generating information file 140, reads and collects the DTD file 123, the XRT file 124, the field information 125, the part XRT file 126 and the external resource file 127, as required, from the parts server 1200 (arrow B6), and combines these files and the user data file thereby to generate the XRF file. The XRF file thus generated is submitted to the request data analyzing section 131, and is also sent by the application server 117 to the client 20 (arrow B10), so as to be processed by the XRF reader 222. A user of the client 20 can use the functions of the print control section 222a of the XRF reader 222 to develop the XRF file into print data, so that the data is sent to the printer 30 via the printer driver 223 thereby causing the printer 30 to output the voucher. In case a parameter that prohibits printing is included in the XRF file, however, printing operation is disabled.

In case the PDF file format is specified as the output file mode for the voucher data in the output file mode descriptor section 1411 of the voucher generating information file 140, the PDF file generating section 135 of the XML application 133 interprets the voucher generating information file 140 and reads and collects the DTD file 123, the XRT file 124, the field information 125, the part XRT file 126 and the external resource file 127 from the parts server 1200 as required (arrow B6), combines these files and the user data file and develops the data into image data, thereby to generate a PDF file. The PDF file thus obtained is submitted to the request data analyzing section 131, and is sent to the Web browser 221 of the client 20 via the application server 117 (arrow B8). When the user makes a predetermined operation on the input device 213 while the Web browser 221 is displaying the received PDF file, print data that corresponds to the voucher data of PDF format is generated and is sent to the printer 30 via the printer driver 223 (arrow B9).

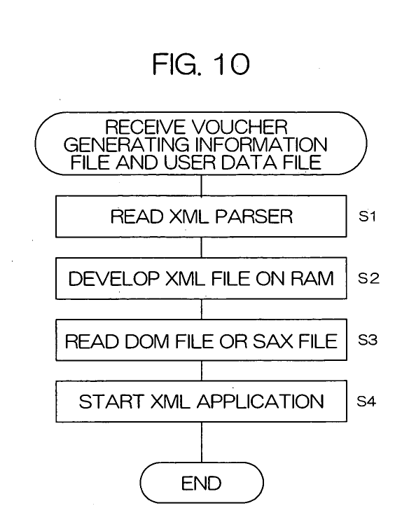

FIG. 10 is a flow chart explanatory of the operation of the data collection and combination processing section 132 that has received the voucher generating information file and a user data file. Upon receipt of the voucher generating information file and the user data file, the data collection and combination processing section 132 reads the XML parser 120 from the storage device 115 (step S1). The XML parser 120 analyses the voucher generating information file (XML file) which the data collection and combination processing section 132 has received.

When the voucher generating information file is analyzed by the XML parser 120, the voucher generating information file is developed on the RAM 112 according to the results of analysis (step S2). Then the DOM file or SAX file 121 is read from the storage device 115 (step S3).

Then the XML application 133 is started (step S4). The XML application 133 uses the DOM file or SAX file 121 so as to operate in accordance with the voucher generating information file while making reference to the voucher generating information file which has been developed on the RAM 112.

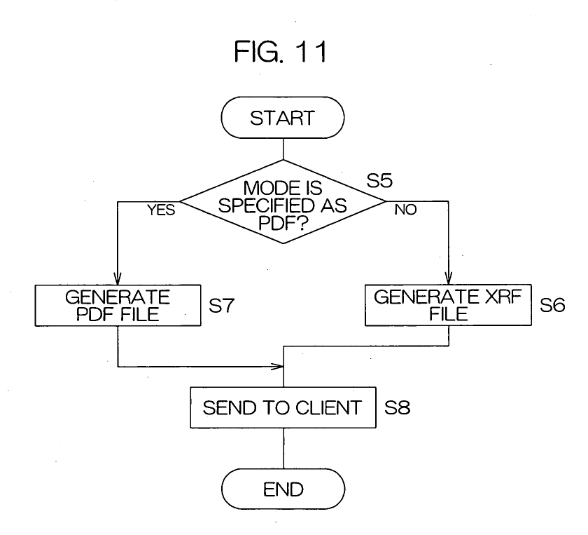

FIG. 11 is a flow chart explanatory of the operation of the XML application 133. When the XML application 133 is started, it is determined in the output file mode descriptor section 1411 of the voucher generating information file 140 whether PDF file mode is specified as the output file mode or not (step S5). If the output file mode descriptor section 1411 does not include a description that specifies the PDF file format (NO in step S5), an XRF file is generated by the action of the XRF file generating section 134 (step S6). If the output file mode descriptor section 1411 of the voucher generating information file 140 includes a description that specifies the PDF file format (YES in step S5), a PDF file is generated by the action of the PDF file generating section 135 (step S7). The XRF file or PDF file that has been generated in this way is sent to the client 20 as a voucher data file (step S8).

Now referring to FIG. 7 again, when the XRF file 150 generated by the XML application 133 is sent via the application server 117 to the XRF reader 222 (started as a helper application by the Web browser 221 upon receipt of the XRF file) (arrow B10), the XRF reader 222 generates image data of the voucher image from the XRF file 150 and displays it on the display device 214. Then, when printing operation is carried out in the XRF reader 222, print data of the voucher image is sent to the printer 30 via the printer driver 223 so that the voucher image is printed on a paper sheet.

The XRF file 150 is supplied from the server 10 to the client 20 via a communication network such as the Internet, as described above. And the user of the client 20 can obtain the desired voucher by developing the XRF file 150 into image data of the voucher on the client 20 side. The XRF file 150 has smaller data size than that of the image data of the voucher after being developed. This enables it to reduce the amount of data transmitted over the network. That is, Voucher desired by a user can be provided while reducing the amount of data transmitted over the network, by sending the XRF file 150 from the server 10 to the client 20.

5. Description of Voucher Data File (XRF File)

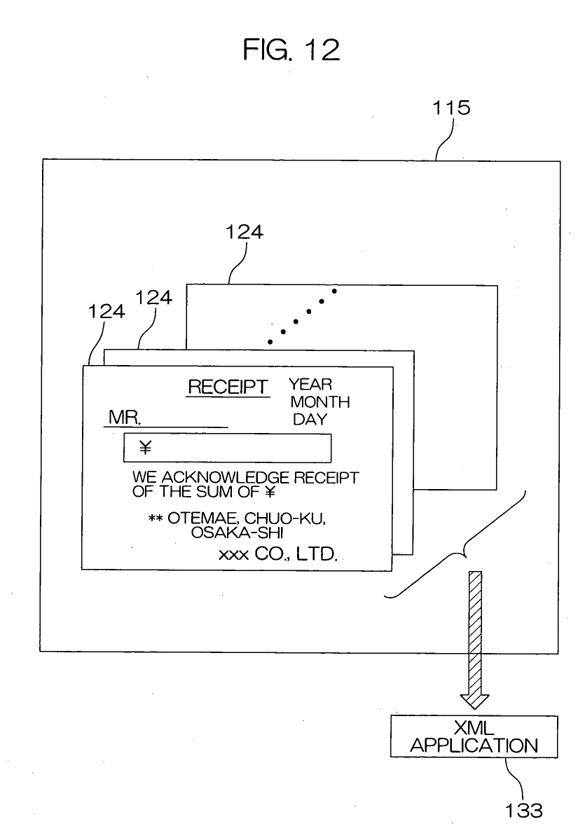

FIG. 12 is a schematic diagram explanatory of the XRT file 124, which is one of major components of the XRF file. The parts server 1200 of the storage device 115 contains a plurality of XRT files 124 stored therein. The XRT file 124 is a form file that defines fixed components of the voucher such as the background and layout for every page. The XML application 133 reads, from the storage device 115, the XRT file 124 that is identified by the XRF file identifying information descriptor section 142 of the voucher generating information file 140. When a plurality of voucher data requests to be processed at the same time are received from the Web browser 221 of the client 20, the request data analyzing section 131 generates a voucher generating information file that contains the voucher generating information related to the voucher data of a plurality of pages and sends the file to the data collection and combination processing section 132. In this case, the XML application 133 makes reference to the XRF file identifying information descriptor section 142 that corresponds to each of the plurality of voucher pages described in the voucher generating information file, so as to read a plurality of XRT files 124 from the storage device 115 according to the description in the descriptor section, and generates a voucher data file that corresponds to the voucher of the plurality of pages.

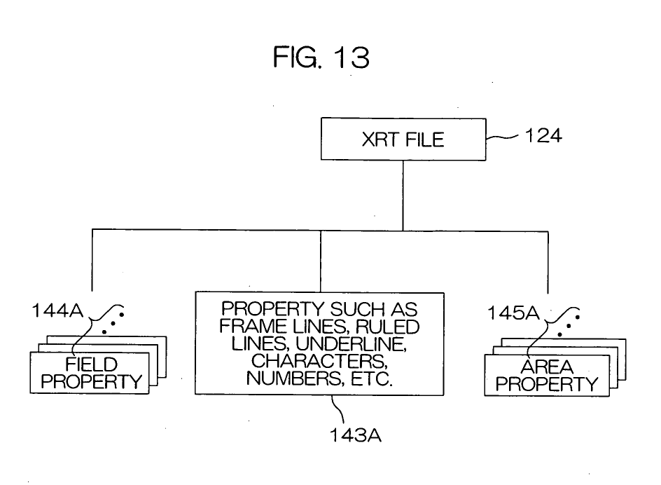

FIG. 13 is a block diagram explanatory of the constitution of the XRT file 124. The XRT file 124 is a form file and has fixed part property 143A that describes the location, type and other attribute information (property) of the fixed parts (frame lines, ruled lines, underline, text (characters and numbers), image, drawing object, etc.) which are disposed in a fixed arrangement on the voucher form, field property 144A that describes attribute information (property) which includes the locations of the fields having serial numbers assigned thereto automatically in the order of being arranged on the voucher form, and area property 145A that describes the attribute information (property) such as the location and size of the area where the part XRT files are arranged and the part XRT file name to be linked. A field is an area in which variable information (information which varies from one voucher to another) is embedded such as character strings, numerical data and image that vary depending on the user data, and is established in the XRT file in advance.

In case the fixed part is a text, such a text is written directly in the XRT file. In case the fixed part is an image, path and file name of the corresponding image file are described as the property in the XRT file, and the image file is stored as an external resource file in the parts server 1200. In case the fixed part is a drawing object, properties thereof such as shape, location, color and size are described in the XRT file.

The part XRT file has the same format as the XRT file, but is different from the ordinary XRT file only in that the part XRT file is not a file which defines a voucher form of one page, and is embedded in an area which is set in the XRT file. Therefore, the part XRT file has a constitution similar to that of the XRT file. It is also possible to set an area in a part XRT file and embed another part XRT file in the area.

The XRT file 124 usually has the fixed part property 143A and the field property 144A related to one or more field, while the area property 145A is not necessarily required. In some cases, the XRT file 124 may not have any field.

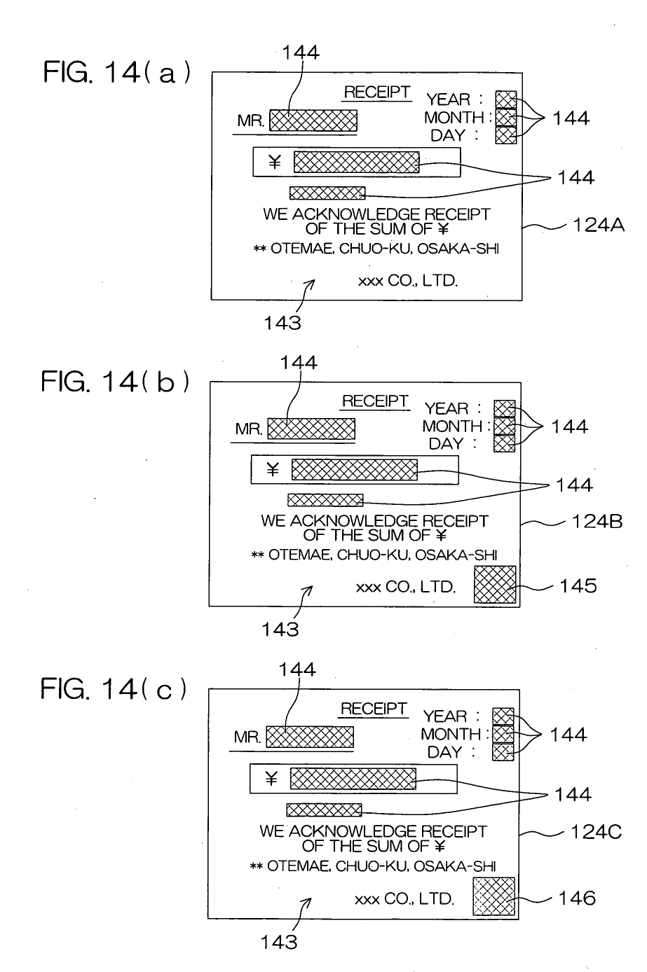

FIGS. 14(a), 14(b) and 14(c) show specific examples of the constitution of the XRT file 124. XRT files 124A, 124B and 124C shown in FIGS. 14(a), 14(b) and 14(c) respectively are form files of a receipt which has common fixed parts 143 such as ruled lines, frame lines, underline, characters, numbers, image, drawing object, etc., and common fields 144 (destination field, date field, sum field, remark field) being set therein, and include description of the properties thereof. The XRT file 124B shown in FIG. 14(b) has an area 145 located at the bottom right thereof, in addition to the constitution of the XRT file 124A shown in FIG. 14(a), and includes the properties of the area. The XRT file 124C shown in FIG. 14(c) has, in addition to the constitution of the XRT file 124A shown in FIG. 14(a), fixed part 146 (character string, image, drawing object, etc.) located at the bottom right.

The XRT files 124A, 124B and 124C shown in FIGS. 14(a), 14(b) and 14(c) respectively are separately stored in the storage device 115. Thus the server 10 can supply vouchers of receipt of various forms to the client 20.

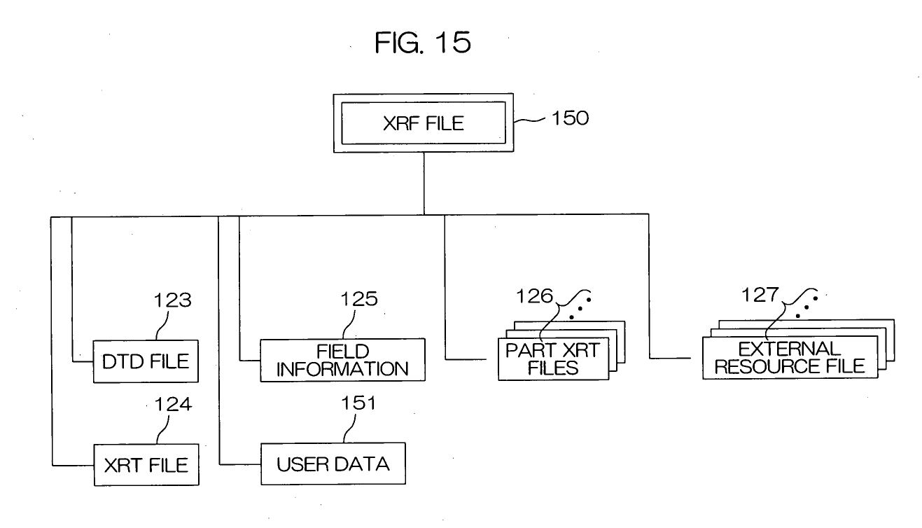

FIG. 15 is a block diagram explanatory of the constitution of the XRF file. The XRF file 150 is constituted from the DTD file 123, the XRT file 124, the field information 125 which has one-to-one correspondence to the XRT file 124, and a user file 151. In case an area is set in the XRT file 124 which is included in the XRF file 150, the XRF file 150 further includes the same number of part XRT files 126 (part XRT files linked to each area) as the number of areas. In case the XRT file 124 included in the XRF file 150 has a field matched to the image data, or has such a form as the image is pasted as a fixed part, the XRF file 150 further includes an external resource file 127 that corresponds to such an image.

6. Generation of Voucher Image

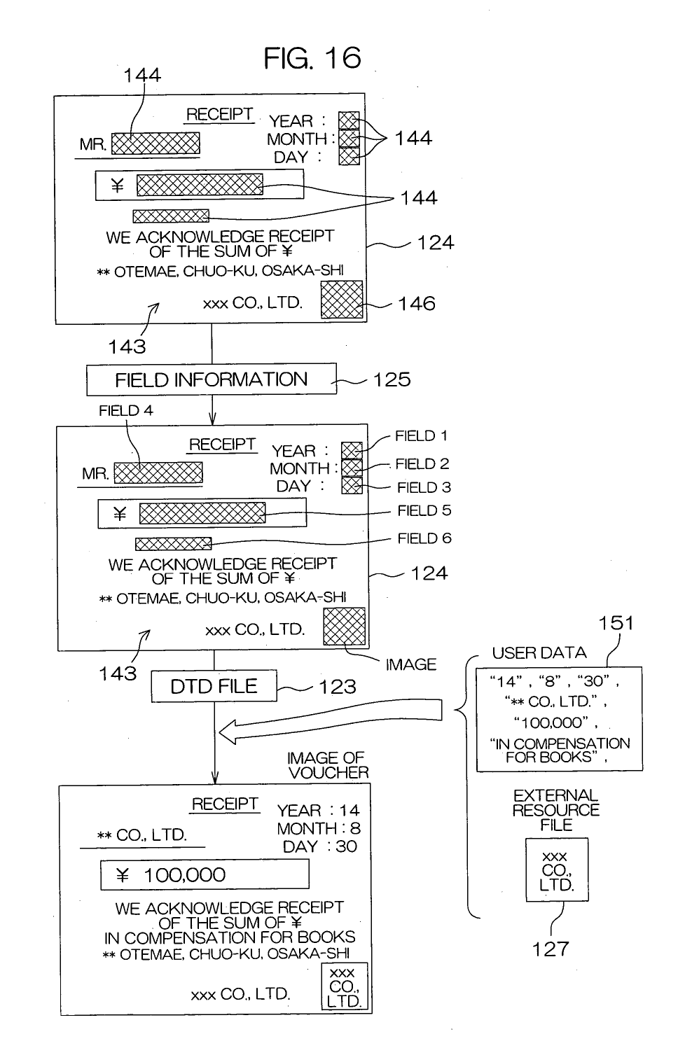

FIG. 16 is a flow chart illustrative of a process in which the image of a voucher is generated according to the XRF file. The XRT file 124 has six fields 144 and one fixed part 146 having an image pasted directly thereon. Consequently, the XRF file 150 that has the XRT file 124 includes the DTD file 123, the field information 125, the user data file 151 and one external resource file 127 (image file). The user data file 151 is a file which records the user data that is identified by the voucher data request corresponding to the data specified by the user from the client 20, wherein information to be inserted in the field areas 144 is recorded by using punctuation symbols (comma in this example (in the so-called CSV format)) such as “14, 8, 30, ** Co., Ltd., 100,000, In compensation for books.”

While appropriate user data is usually read from the parts server 1200 according to the conditions specified by the voucher data request, in some cases content to be written in each field may be directly specified from the client 20.

The field information 125 represents the relation between the field 144 which is set in the XRT file 124 and the DTD file, and indicates the data type of each field (characters, numerical data, bar code, image, etc.), the order in which the fields are set and the number of fields. The DTD file includes the information, described therein, that makes correspondence between each field and the user data via the field information. In case the data of the field is of the type that can be represented by a numerical value such as characters, numerical value or a bar code, data that corresponds to each field is stored in the parts server 1200 as the user data. In case the data type of the field is image, the user data includes the path and the name of the image file, while the image file is stored in the parts server 1200 as an external resource file.

When an XRT file is generated in advance by using a drawing application, properties of the individual fields are recorded in the XRT file. The properties include the order in which the fields were set. When setting the field, field information is generated.

The DTD file 123 includes information that makes correspondence between the field area 144 and the user data. The XRF reader 222 and the PDF file generating section 135 make reference to the DTD file 123 and, in accordance with the field information 125 and the properties of the individual fields (particularly the information related to the order in which the fields were set), embed the user data and the external resource file 127 in each field and develop the data into image data.

In the XRT file 124 shown in FIG. 16, for example, the first information “14” of the user data file 151 is embedded in the field 1 that is set first, the second information “8” of the user data file 151 is embedded in the field 2 that is set second, the third information “30” of the user data file 151 is embedded in the field 3 that is set third, the forth information “** Co., Ltd.” of the user data file 151 is embedded in the field 4 that is set fourth, the fifth information “100,000” of the user data file 151 is embedded in the field 5 that is set fifth, and the sixth information “In compensation for books” of the user data file 151 is embedded in the field 6 that is set sixth. It should be noted that the order of setting the fields and the order of arranging the user data should not necessarily be matched, since correspondence between the order of setting the fields and the user data is described in the DTD file 123.

The XRF reader 222 and the PDF file generating section 135 also develop the fixed part 143 of the voucher form into image data according to the property described in the XRT file 124. For an area where an image is to be pasted such as the fixed part 146, an external source file (image file) is embedded and developed.

The image of the voucher is generated as described above. In the XRF reader 222, the image of the voucher thus generated is converted into display image data and is, when printing operation is carried out, converted into print data and is sent to the printer 30 via the printer driver 223.

7. Mode of Using Part XRT File

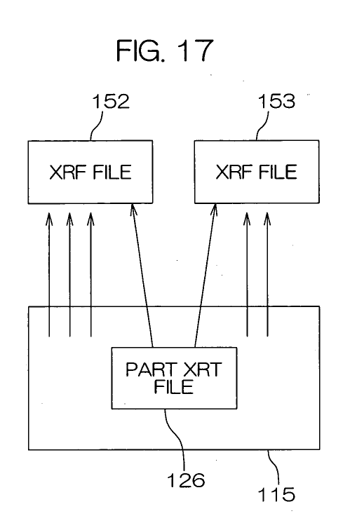

FIG. 17 is a schematic diagram explanatory of an example of using the part XRT file 126. In this schematic diagram, the XRF files 152, 153 include XRT files that have areas which are commonly linked to one part XRT file 126.

The XRF file generating section 134 of the XML application 133 reads the XRT file 124 that corresponds to the voucher data request from the parts server 1200 of the storage device 115 according to the voucher generating information file 140, and reads the part XRT file 126 that is linked to the XRT files 124 from the parts server 1200 and combines these files so as to generate the XRF files 152, 153.

In the example shown in FIG. 17, one part XRT file 126 stored in the storage device 115 is used in common for generating the XRF files 152, 153. In this way, there may be a case where there is one part XRT file 126 which is used in common for a plurality of XRF files. Memory capacity of the storage device 115 required by the server 10 to provide various voucher data (XRF file 150) can be reduced, for example, by generating the part XRT file 126 that corresponds to the image or text of the company seal or company name in advance and storing this file in the parts server 1200 of the storage device 115.

The part XRT file allows it to arrange fixed parts therein (character strings, numerical data, bar code, image), set fields therein and set an area therein which is linked to other part XRT file. Therefore, parts of voucher of various forms can be generated and various parts to be used in common in a plurality of voucher forms can be generated in advance by using the part XRT file.

8. Operation of XRF Reader

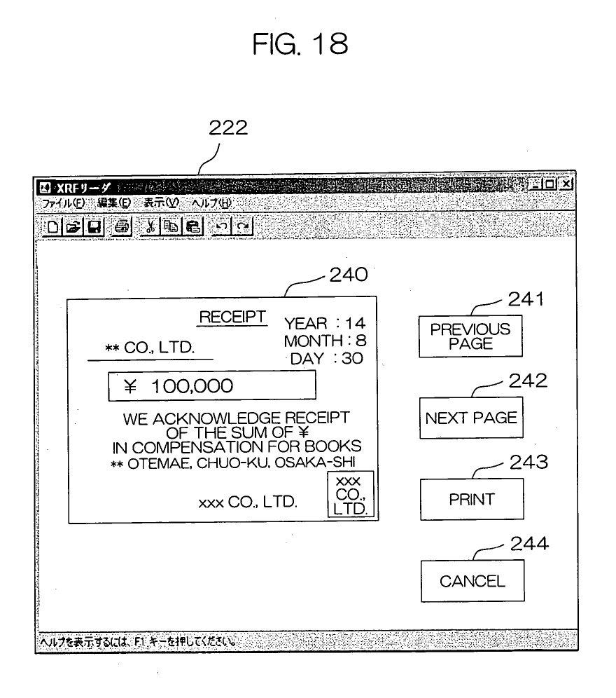

FIG. 18 shows an example of the display of XRF reader 222 which has received the XRF file 150. When the XRF file 150 is received from the server 10 at the client 20 and is viewed by means of the XRF file reader 222, the XRF reader 222 shows an image of voucher 240 generated from the XRF file 150, a PREVIOUS PAGE button 241, a NEXT PAGE button 242, a PRINT button 243 and a CANCEL button 244. These buttons can be operated (clicked) by means of the input device 213.

Even when the XRF reader 222 receives XRF files 150 corresponding to voucher data that includes a plurality of pages of voucher, the XRF reader 222 can display the voucher image 240 only one by one. The PREVIOUS PAGE button 241 and the NEXT PAGE button 242 allow it to view the voucher image 240 one by one by pressing the buttons. When the PRINT button 243 is pressed while the voucher image 240 is displayed, the print dialog box is opened. When the operation to start printing is made after setting the printing conditions in the print dialog box, the XRF reader 222 sends the print data that corresponds to the voucher image 240 via the printer driver 223 to the printer 30 (arrow B11 in FIG. 7). This causes the voucher image 240 to be printed on a paper sheet by the printer 30.

While printing of the voucher can be canceled by pressing the CANCEL button 244, the CANCEL button 244 cannot be operated before closing the print dialog box which is opened after pressing the PRINT button 243.

The screen of the XRF reader 222 may comprise arrow buttons or the like disposed in a menu bar, instead of the buttons disposed in the screen as described above.

When the operation to start printing is made in the print dialog box, the print dialog box is automatically closed and the in-printing dialog box appears to indicate that printing is currently in operation. Depending on the type of voucher (receipt, for example), the in-printing dialog box may be set as a system modal dialog box. In this case, other operations including the operation of the operating system may be disabled until the in-printing dialog box is closed. That is, such a constitution may be provided as other operations are disabled and the printing operation cannot be canceled until the printing is completed, once it is started. With this constitution, such a situation can be avoided as an incomplete voucher is generated and illegally used. When the printing process is completed (upon the end of print data output or receipt of printing complete signal from the printer, for example), the in-printing dialog box is automatically closed.

In case the XRF file 150 that has been received includes a parameter which prohibits screen display, the voucher image 240 is not displayed and only the buttons 241 through 244 are displayed. This enables it to prevent voucher image data from being copied on the screen, while allowing printing output only.

In case the XRF file 150 that has been received includes a parameter which prohibits printing, for example, the PRINT button 243 is disabled to operate (for example, displayed in gray), thus making printing operation impossible.

In case the XRF file 150 that has been received includes a parameter which disables the display of print dialog box, print dialog box will not be displayed even when the PRINT button 243 is pressed, while the printing is processed in the background. This enables it to prevent a voucher from being printed in plurality.

In case the XRF file 150 that has been received includes a parameter which disables the display of the in-printing dialog box, printing operation is processed without displaying the in-printing dialog box. This enables it to prevent printing of a voucher from being interrupted incomplete, by not displaying the in-printing dialog box, even in case a button for interrupting printing operation is provided in the in-printing dialog box.

Moreover, in case the XRF file 150 that has been received includes a parameter which prohibits it to save XRF files, the XRF reader 222 is disabled to save the XRF files.

9. Generation of Part XRT File

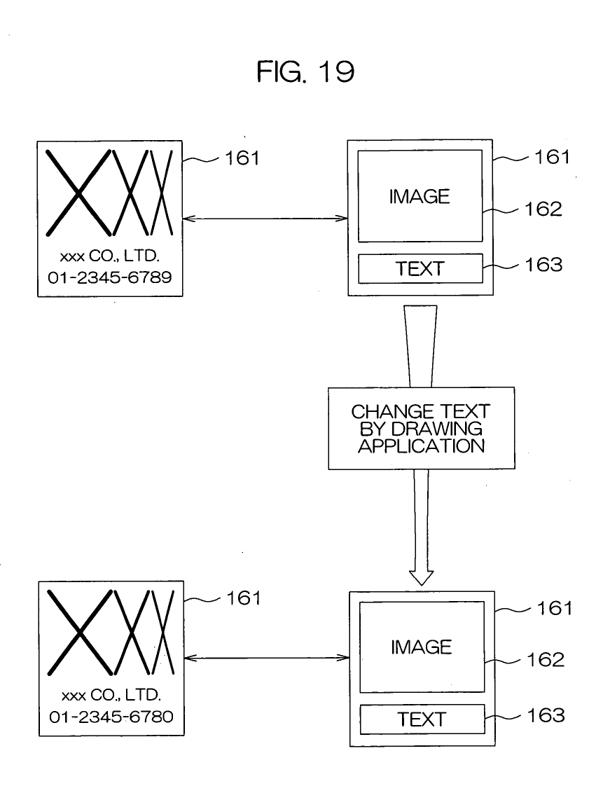

FIG. 19 is a schematic diagram explanatory of the mode of using the part XRT file. An XRT file that constitutes a voucher form and a part XRT file that is pasted in an area specified in the XRT file are generated in advance by using a drawing application and is stored in the parts server 1200 of the server 10. The drawing application allows it to secure an area when generating the XRT file and generate a part XRT file in the area. The part XRT file generated in this way can be pasted onto another XRT file or another part XRT file so as to be used again.

When the area is secured, area property is written in the XRT file. The area property includes the information on the area size and its location in the XRT file.

When an existing part XRT file is imported into the XRT file, the part XRT file is pasted at the active cursor position on the screen of the drawing application wherein the contents of the XRT file are displayed. At this time, the area property is written in the XRT file. The area property includes the information on the position where the part XRT file is pasted and the area size. Size of the area in this case is equal to the area size secured when the part XRT file was generated first.

The part XRT file 161 shown in FIG. 19 includes an area 162 in which an image file is pasted as a fixed part and an area 163 in which text data is pasted. In this example, the area 162 has an image file representing the logo of xxx Co., Ltd. pasted therein and the area 163 has text data of “xxx Co., Ltd., 01-2345-6789” pasted therein. As mentioned above, fields can be set in the part XRT file similarly to the case of the XRT file, and user data such as characters and numbers and image data can be pasted in the fields.

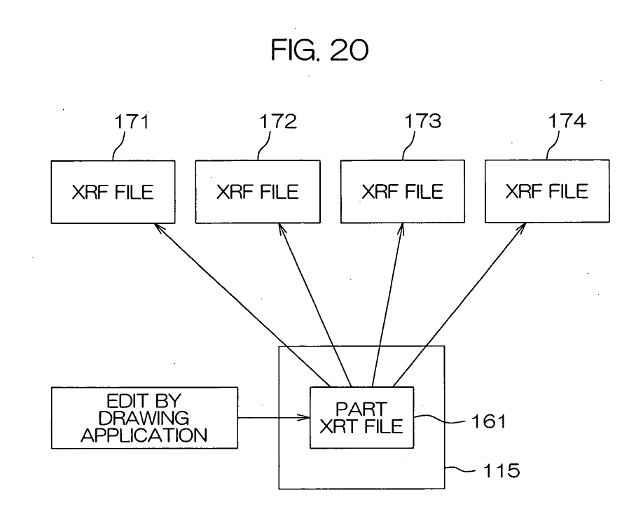

FIG. 20 is a schematic diagram explanatory of the mode of using the part XRT file 126. XRF files 171, 172, 173, 174 each include XRT files which have areas that are commonly linked to the part XRT file 161 stored in the storage device 115.

Now assume that it is required to change the text data of “xxx Co., Ltd., 01-2345-6789” of the area 163 to “xxx Co., Ltd., 01-2345-6780.”

The administrator of the server 10 can edit the text data in the area 163 of the part XRT file 161 to change it to “xxx Co., Ltd., 01-2345-6780.” The part XRT file 161 which has been changed is stored, for example, by overwriting on the storage device 115 by the drawing application. The image file of the area 162 can also be changed similarly.

After the part XRT file 161 that has been changed is stored in the storage device 115, the XRT file is caused to include the changed part XRT file 161 as a component thereof when XRT file that includes the part XRT file 161 as a component is generated.

As a result, administrator of the server 10 can edit the part XRT file 126 so as to cause the result of editing to be reflected commonly to vouchers of a plurality of types which are generated by using the part XRT file 126.

10. Alteration of Appearance According to User Data

10-1. Selection of Image Parts According to User Data

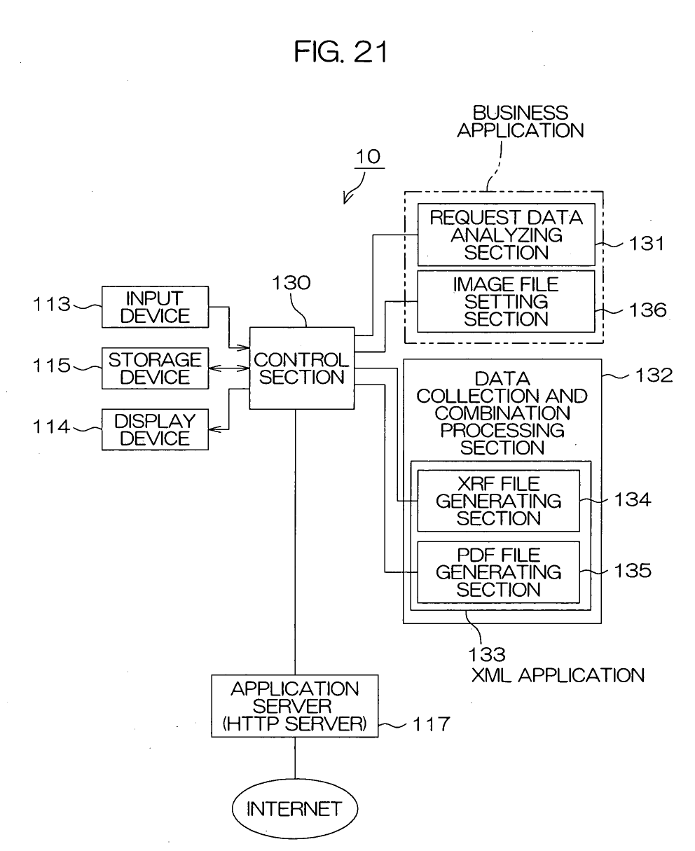

FIG. 21 is a block diagram explanatory of an example of the constitution of the server 10 which has a function to change the appearance of voucher according to user data. In FIG. 21, parts equivalent to the components parts shown in FIG. 4 are assigned with reference numerals identical to those of FIG. 4 and description thereof will be omitted. The business application of the server 10 has, in addition to the function of the request data analyzing section 131 described previously, the function of the image file setting section 136 that determines an appropriate image file in accordance with the user data and writes the path and file name of the image file in the voucher generating information file.

There may be such a case in which the request data analyzing section 131 generates voucher generating information such that the XRT file, wherein an area is set for pasting one image file selected from among a plurality of image files according to the user data, should become a component of the voucher data file. In this case, the request data analyzing section 131 submits the user data which has been read from the client 20 in response to voucher data request to the image file setting section 136. In accordance with the user data which is submitted, the image file setting section 136 identifies the image file to be pasted in the area of the XRT file, and writes the path and name of the file in the voucher generating information file.

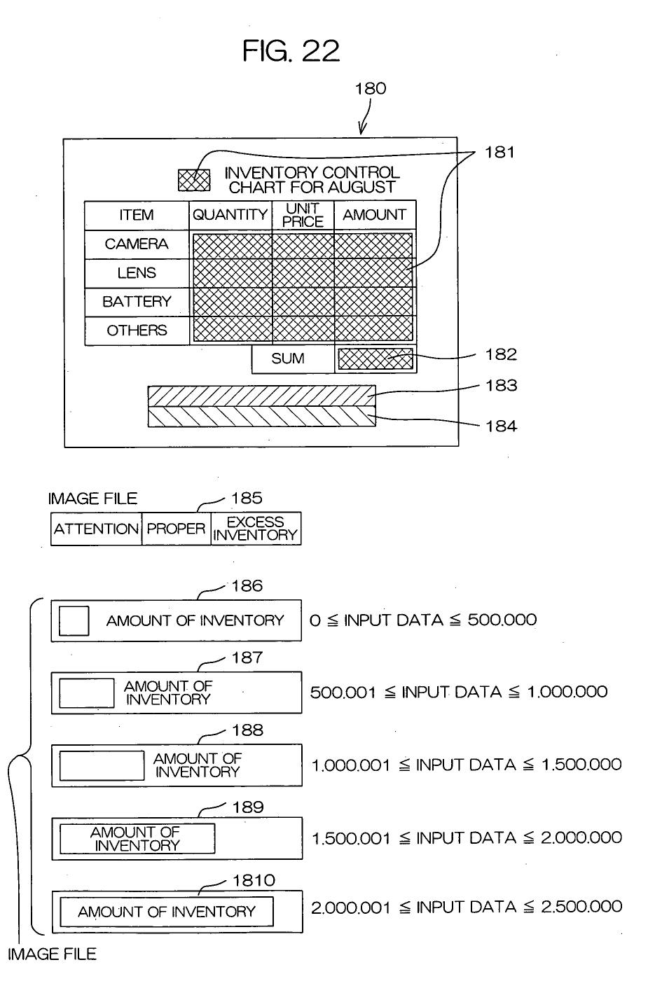

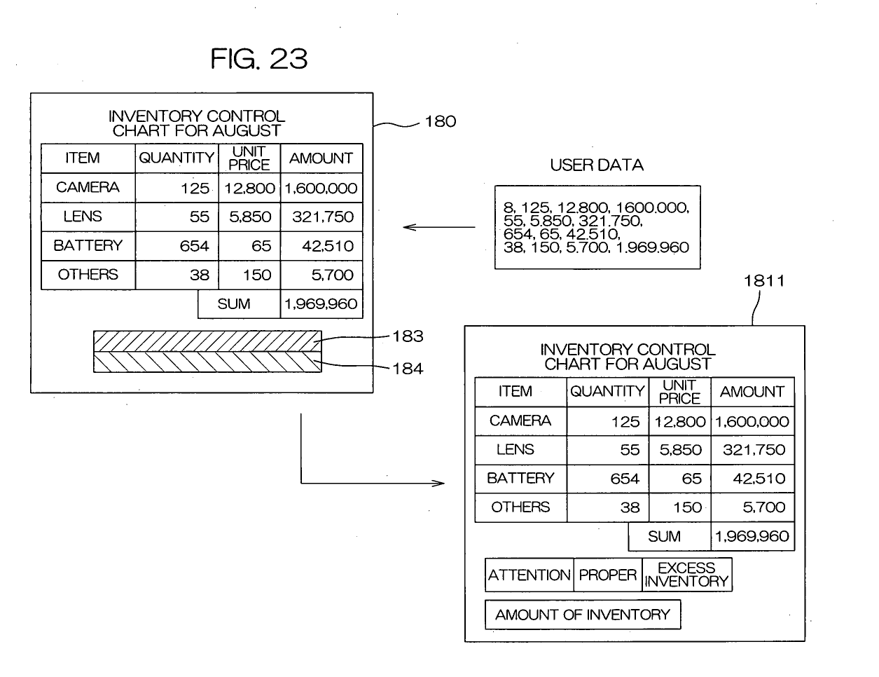

FIG. 22 is a schematic diagram explanatory of the function of the image file setting section 136. FIG. 23 is a schematic diagram explanatory of an example of voucher data (XRF file) supplied from the server 10 to the client 20.

In the schematic diagram of FIG. 22, the XRT file 180 which is a component of the voucher data has, being set therein, 14 fields 181, 182 where text or number is specified as the data type, an area 183 where an image is pasted therein, and an area 184 which is set for pasting one image file selected from among a plurality of image files therein. The storage device 115 has image files 185, 186, 187, 188, 189 and 1810 stored therein. The area 183 has the image file 185 being pasted therein as a fixed part.

The image file setting section 136 identifies one of the image files 186 through 1810 as the image file to be pasted in the field 184 in accordance with the value of user data identified by the voucher data request which is given by the client 20. For example, operation of the image file setting section 136 is set so as to write such information (path and file name) in the voucher generating information file 140 that identifies, as the image file to be embedded in the area 184, the image file 186 when the value of 14th input data ID is 0≦ID≦500000, the image file 187 when 500001≦ID≦1000000, the image file 188 when 1000001≦ID≦1500000, the image file 189 when 1500001≦ID≦2000000, and the image file 1810 when 2000001≦ID≦2500000.

In this embodiment, the image files 186 through 1810 are constituted from horizontally elongated belt-shaped figures of different lengths and character strings “Current amount of inventory.” Lengths of the belt-shaped figures visually represent the amounts of inventory. Portions of the belt-shaped figures and/or the portions of the character strings may also be displayed in different colors as required. For example, portions of the belt-shaped figures of image files 186, 1810 indicating shortage or excess in the amount of inventory may be displayed in red, portions of the belt-shaped figures of image file 188 indicating proper amount of inventory may be displayed in green and the other image files 187, 189 may be displayed in yellow, so that the inventory conditions can be grasped at a glance.

Assume that the value of 14th input data is “1969960” as shown in FIG. 23. Then the image file setting section 136 writes the path and file name of the image file 189 in the voucher generating information file 140 as the path and file name of the image file to be embedded in the area 184.

The XML application 133 then generates an XRF file or a PDF file based on the voucher generating information file 140. Image of voucher 1811 shown in FIG. 23 is displayed by the XRF reader 222 in accordance with the generated XRF file 150.

The image of voucher 1811 is the image that shows the “Inventory control chart for August.” The image of voucher 1811 is designed to allow it to easily understand visually that the amount of inventory in August period is within a normal range.

The parameters used by the image file setting section 136 to select the image file may be made variable so that the server administrator can change them. Setting of the user data which is the object of checking the parameter may also be made variable. Moreover, setting of the image file (external resource file) which is identified by the image file setting section 136 may also be made variable.

Vouchers having different appearances according to the user data can be generated as described above. Furthermore, since a plurality of image files used selectively in one voucher form are stored separately from the data of the voucher form, it does not impose significant load on the storage capacity of the storage device 115.

In the example described above, an image file selected in accordance with the value of user data is pasted in a particular area. However, with similar constitution and process, such an operation may also be carried out as one of a plurality of part XRT files (part forms) is selected according to the value of the user data and is linked to the area, by changing the property of the area, which is set in the XRT file as a voucher form file, according to the user data. This operation also enables it to generate vouchers having various appearances according to the user data.

10-2. Alteration of Property of Drawing Object According to User Data

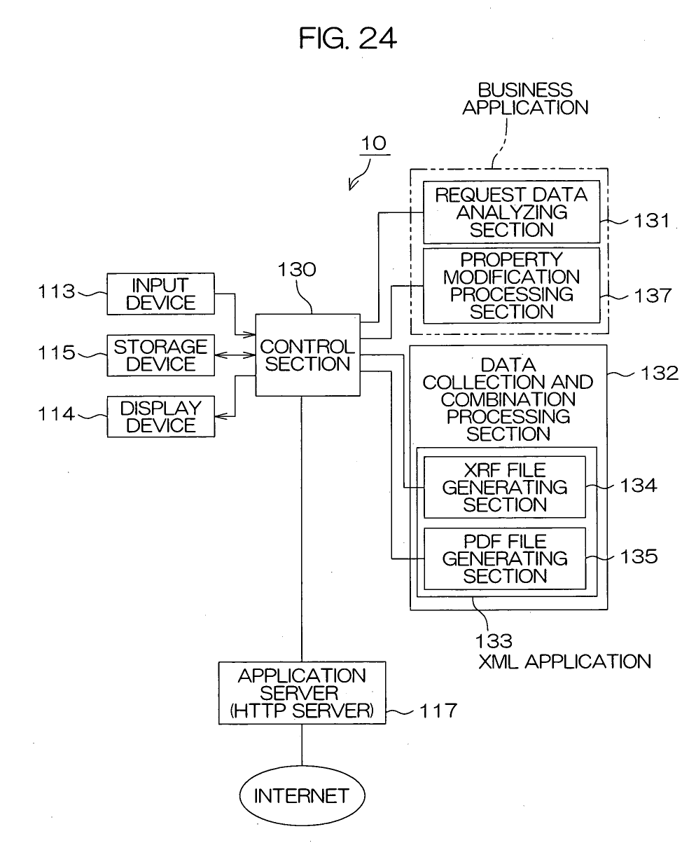

FIG. 24 is a block diagram explanatory of another example of constitution of the server 10 used to change the appearance of voucher according to user data. In FIG. 24, components equivalent to those shown in FIG. 4 are assigned with reference numerals identical to those of FIG. 4 and description thereof will be omitted.

The business application of the server 10 has, in addition to the function of the request data analyzing section 131 described previously, the function of a property modification processing section 137 that changes the properties of drawing objects (graphic data such as line, circle, rectangle, polygon, arc and fan shape).

There may be such a case that the XRT file that corresponds to the voucher data request from the client 20 has a drawing object pasted thereon as a fixed part. In this embodiment, properties can be automatically changed according to the user data for a particular drawing object.

When generating an XRT file using the drawing application, the drawing object may be placed on a voucher form. The drawing application has the editing function for editing the drawing object, so as to select a drawing object of a desired shape and placing it at a desired position on the voucher, for example, by the dragging operation of a mouse, or changing the shape and size of the drawing object by the similar dragging operation of the mouse. The drawing object thus generated has properties such as the pasting position in the voucher form, size, kind of line (profile line, etc.) and color. These properties can be changed through input operation in the edit property dialog box on the drawing application. The properties generated in such a manner are described in the XRT file.

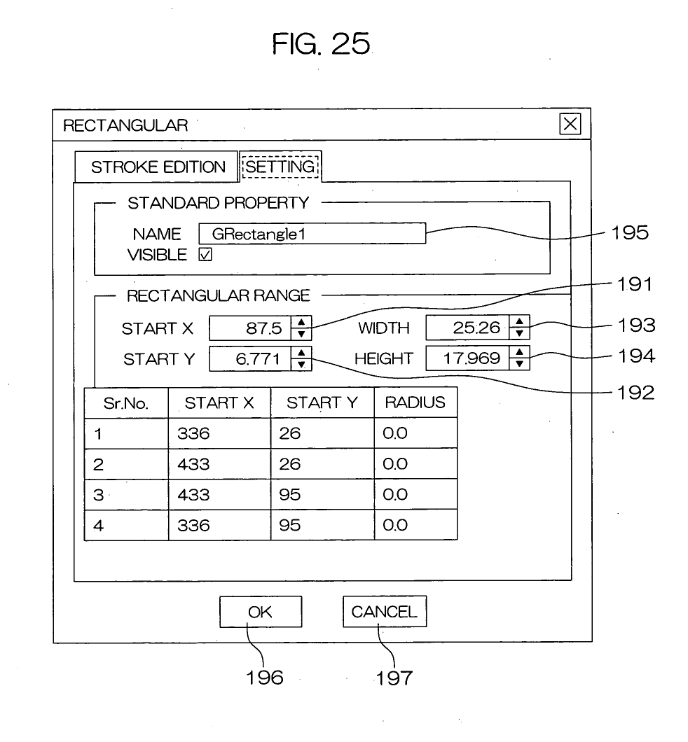

FIG. 25 shows an example of display of the edit property dialog box for a drawing object corresponding to a rectangular figure. Displayed in the edit property dialog box are position data 191 that represents the horizontal position of the top left corner of the rectangular figure, position data 192 that represents the vertical position of the top left corner of the rectangular figure, length data 193 that represents the horizontal length of the rectangular figure and length data 194 that represents the vertical length of the rectangular figure.

In this example, horizontal position data 191 of the top left corner of the rectangular figure is “87.5”, vertical position data 192 is “6.771”, horizontal length data 193 is “25.26”, and vertical length data 194 is “17.969”. When the values of data 191 through 194 are changed, position, size and shape (aspect ratio) of the rectangular drawing object change accordingly.

The edit property dialog box for the drawing object also includes an object name setting section 195, an OK button 196 and a CANCEL button 197. These buttons can be operated (clicked) by means of mouse or the like. When the OK button 196 is operated, values of the properties are confirmed and written as default values in the XRT file.

The property modification processing section 137, according to the values of user data that correspond to the voucher data request from the client 20, determines proper values for a particular drawing object in the XRT file. The property modification processing section 137 then writes a command in the voucher generating information file for directing to change values of the properties of the drawing object to the determined values. For example, the property modification processing section 137 writes a command in the voucher generating information file for changing the values of data 191 through 194 in the property to such values that correspond to the user data.

Thus the voucher generating information file that includes the command for changing the position, size and shape (and also color, as required) according to the value of user data is generated, and is sent to the data collection and combination processing section 132.

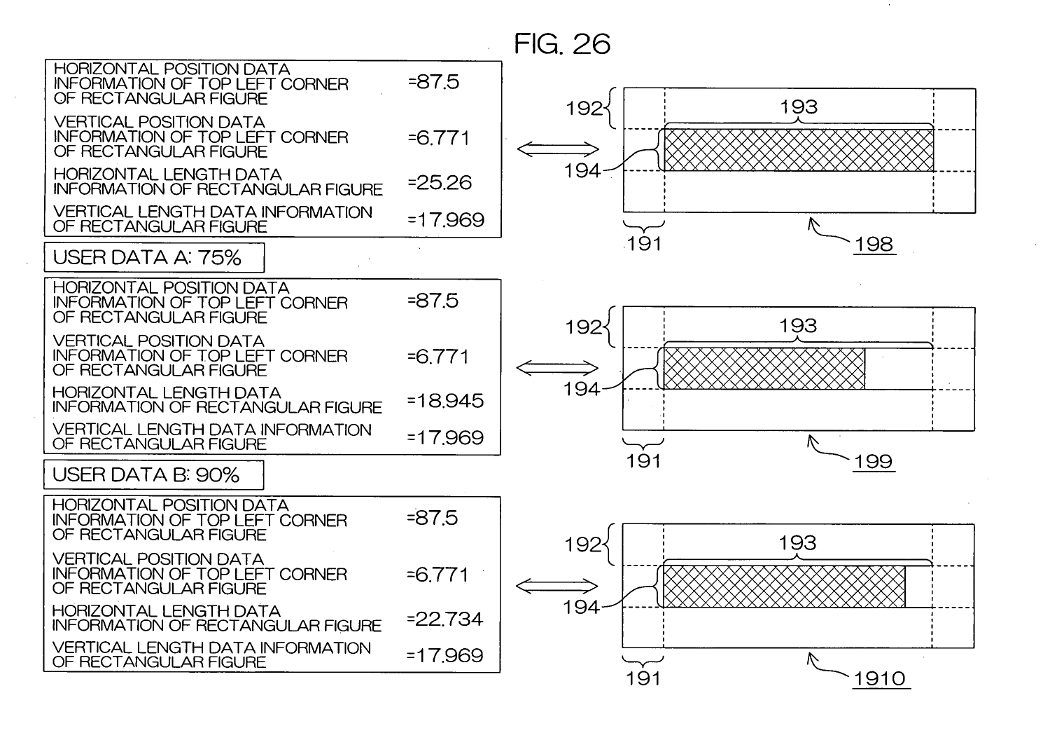

FIG. 26 is a schematic diagram explanatory of deformation of a rectangular figure due to a change in the property of the drawing object in accordance with the value of user data. Assume such a situation as properties of a rectangular drawing object is described in a voucher form file (XRT file) that corresponds to the voucher data request from the client 20. It is also assumed that horizontal position data 191 is set to “87.5”, vertical position data 192 is set to “6.771”, horizontal length data 193 is set to “25.26”, and vertical length data 194 is set to “17.969” as the default property of the rectangular drawing object.

In case analysis by the request data analyzing section 131 indicates that the user data A corresponding to the voucher data request has a value of 75%, for example, the property modification processing section 137 generates a command to change the horizontal length data 193 of the rectangular drawing object from “25.26” to “18.945” which is 75% of “25.26”, and writes it in the voucher generating information file. Accordingly, the XML application 133 of the data collection and combination processing section 132 interprets the command, and changes the XRT file so as to generate the XRT file having changed property of the rectangular drawing object. Then the XRF reader of the client 20 develops the image data of rectangular figure having the horizontal length changed to “18.945”.

In case the user data B that corresponds to the voucher data request has a value of 90%, the property modification processing section 137 generates a command to change the horizontal length data 193 of the rectangular drawing object from “25.26” to “22.734” which is 90% of “25.26”, and writes it in the voucher generating information file. Accordingly, the XML application 133 changes the XRT file so as to change the property of the rectangular drawing object. Then the XRF reader of the client 20 develops the image data of the rectangular figure having the horizontal length changed to “22.734”.

Thus the XRT file having the drawing object of the property (particularly the property related to the shape) that corresponds to the value of user data can be automatically generated.

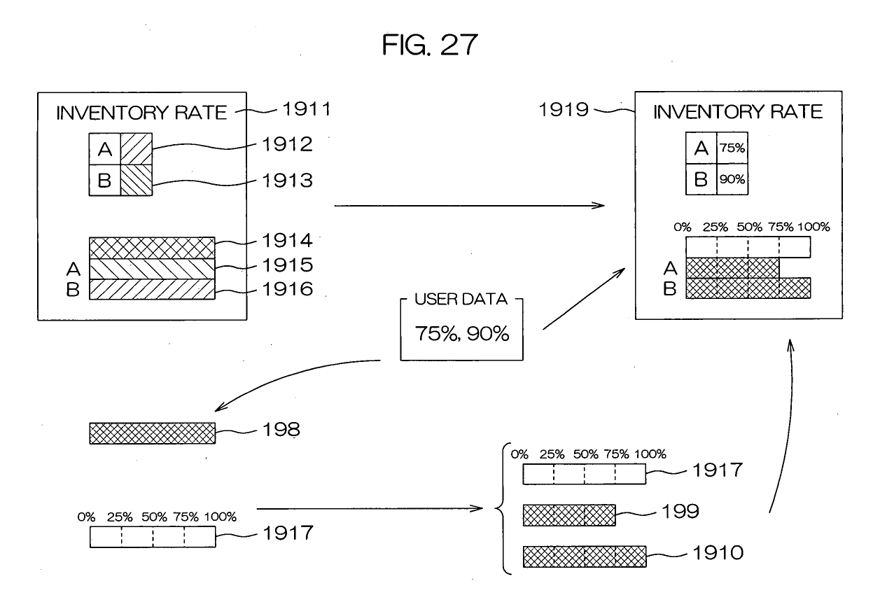

FIG. 27 is a schematic diagram explanatory of an example of voucher data supplied from the server 10 to the client 20. XRT file 1911 is a voucher form file corresponding to the voucher data request (particularly to the portion thereof which specifies the type of voucher) sent from the client 20 to the server 10. In this example, the XRT file 1911 includes fields 1912, 1913 being set therein, and image data 1917 is pasted in the area 1914, while areas 1915, 1916 have rectangular drawing object 198 (having the default property) pasted therein. The image file 1917 which is linked to the area 1914 is stored in the storage device 115, while the XRT file includes the path and file name of the image file 1917 as the property of the image. The property of the drawing object 198 is described in the XRT file.

It is assumed that the property modification processing section 137 describes a command in the voucher generating information file for changing the property of the basic rectangular drawing object 198 pasted in the areas 1915, 1916 to values that match the user data (for example, those corresponding to the fields 1912, 1913).

Now suppose that values of 75% and 90% are read from the parts server 1200 as the user data identified according to the voucher data request, and are supplied to the business application. The request data analyzing section 131 generates a user data file so that first user data of 75% is embedded in the field 1912 and the second user data of 90% is embedded in the field 1913. The property modification processing section 137 generates a command that instructs to change the properties of the drawing objects 198 of the areas 1915, 1916 according to the user data 75% and 90%, respectively, and writes the command in the voucher generating information file. The rectangular drawing objects after changing their properties are denoted with reference numerals 199 and 1910, respectively.

The voucher generating information file 140 which has been generated automatically as described above is interpreted by the XML application 133 and, accordingly, the properties of the rectangular drawing object of the areas 1915, 1916 are changed in the XRT file 1911, and the XRF file 150 that includes the changed XRT file is generated. The XRF file 150 includes the XRT file 1911 (with the property of the drawing object having been changed), the image file 1917, the user data, etc. as the component data. The XRF file 150 is sent via the application server 117 to the client 20 and is displayed by the XRF reader 222, thereby to obtain a voucher image 1919.

The voucher image 1919 is voucher data that indicates the inventory ratio of the articles A and B. The voucher image 1919 has an appearance which can be understood intuitively so as to show the inventory ratio of the articles A and B visually by means of the image file 1917 and the rectangular drawing objects 199, 1910.

In the example described above, horizontal length of the rectangular figure is changed according to the value of user data, although such operation may be carried out as the vertical length is changed or in addition the color of the drawing object is changed in accordance with the value of the user data. Also, although property of the drawing object is changed in accordance with the user data represented in percentage in the example described above, such a constitution may also be employed as a reference value is set in advance in the property modification processing section 136, and property of the drawing object is changed in accordance with the result of comparing the user data and the reference value (for example, the difference between the reference value and the user data).

It needs not to say that the shape of the basic drawing object is not limited to rectangular and may be circle, arc, fan shape or other shape.

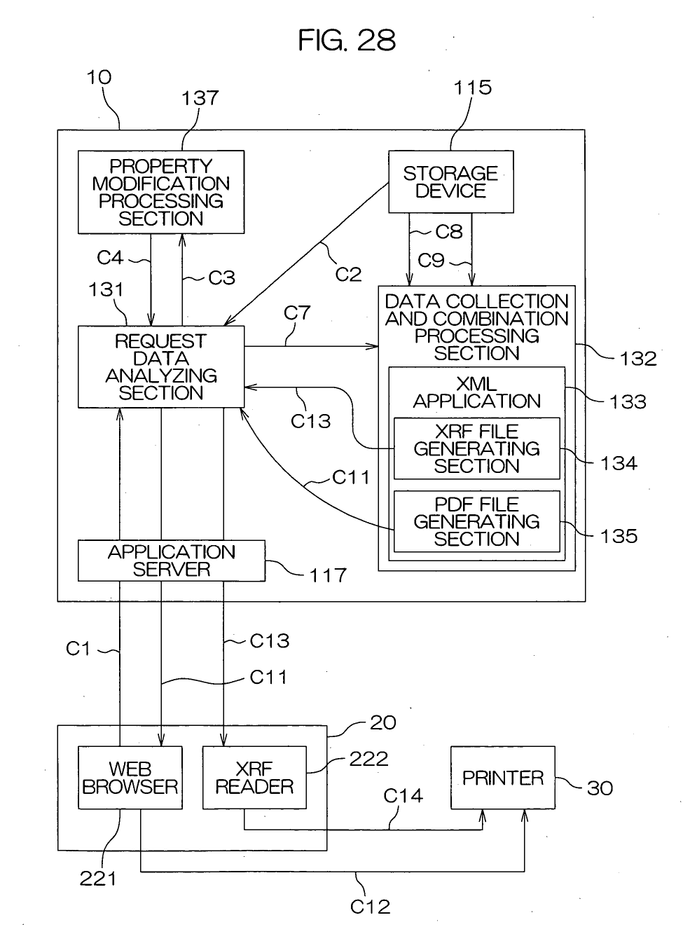

FIG. 28 is a block diagram explanatory of the constitution of the electronic voucher system which achieves a function to change the property of drawing object according to user data. The voucher data request from the client 20 is supplied from the Web browser 221 via the application server 117 to the request data analyzing section 131 (arrow C1). The request data analyzing section 131 reads user data that corresponds to the voucher data request from the storage device 115 (arrow C3).

In case a drawing object which is subject to the property change by means of user data is pasted to the voucher form (XRT file) that corresponds to the voucher data request, the request data analyzing section 131 supplies the user data to the property modification processing section 137 (arrow C3).

The property modification processing section 137, in accordance with the user data provided, generate a command to change the property of the drawing object and writes it in the voucher generating information file (arrow C4).

The request data analyzing section 131 also sends the voucher generating information file 140 for the generation of voucher data corresponding to the voucher data request and the user data 151 to the data collection and combination processing section 132 (arrow C7) The voucher generating information file 140 includes a command that instructs to change the property of the drawing object in the voucher form file (XRT file).

The data collection and combination processing section 132, that has received the voucher generating information file 140 and the user data 151, starts the XML application 133 by reading the XML parser 120 and the DOM file or the SAX file 121 from the storage device 115 (arrow C8). The XML application 133 generates the XRF file 150 by reading the DTD file 123, the XRT file 124, the field information 125, the part XRT file 126 and the external resource file 127 from the storage device 115 according to the voucher generating information file 140 (arrow C9). At this time, the property of the drawing object in the XRT file is changed according to the command generated by the property modification processing section 137.

If PDF file format is not specified in the output file mode descriptor section of the voucher generating information file 140, an XRF file is generated by the XRF file generating section 134 of the XML application 133, and the XRF file is submitted to the request data analyzing section 131. The XRF file is sent to via the application server 117 to the XRF reader 222 (the Web browser 221 starts as the helper application upon receipt of the XRF file) (arrow C13). When a predetermined operation is made on the input device 113 while the XRF reader 222 is displaying the XRT file 150 which has been received, print data of the voucher is sent to the printer 30 via the printer driver 223, so that the voucher is printed on a paper sheet by the printer 30 (arrow C14). In this way, such a voucher is obtained as the drawing object having the property (particularly the form) is changed according to the user data.

In case the PDF file format is specified in the output file mode descriptor section of the voucher generating information file 140, the PDF generating section 135 of the XML application 133 develops the image data of the form that corresponds to the XRT file and further develops the user data, image and drawing object and embeds these data into the image data. The PDF file obtained in this way is submitted to the request data analyzing section 131 and supplied to the web browser 221 of the client 20 via the application server 117 (arrow C11). When the user makes a predetermined operation on the input device 113 while the Web browser 221 is displaying the received PDF file, print data of the voucher is generated and is sent via the printer driver 223 to the printer 30 so that the voucher is printed out by the printer 30 (arrow C12).

In case the voucher form file (XRT file) that corresponds to the voucher data request supplied from the client 20 has a drawing object of which property is inevitably changed according to the user data, such a constitution may also be employed as the request data analyzing section 131 determines that it is necessary to change the property of the drawing object based on the file name of the voucher form file (XRT file), and submits the user data to the property modification processing section 137.

Depending on the voucher, there may be such a situation as it is directed from the client 20 (by including specifying information in the voucher data request) whether to use the default value without changing the property of the drawing object or to change the property of the drawing object. In such a case, the request data analyzing section 131 first determines whether there is an instruction from the client 20 and, if it is specified not to change the property of the drawing object, generation of the command by the property modification processing section 137 may be skipped.

### 11. Embodiment Capable of Caching the Component Files of Voucher Form

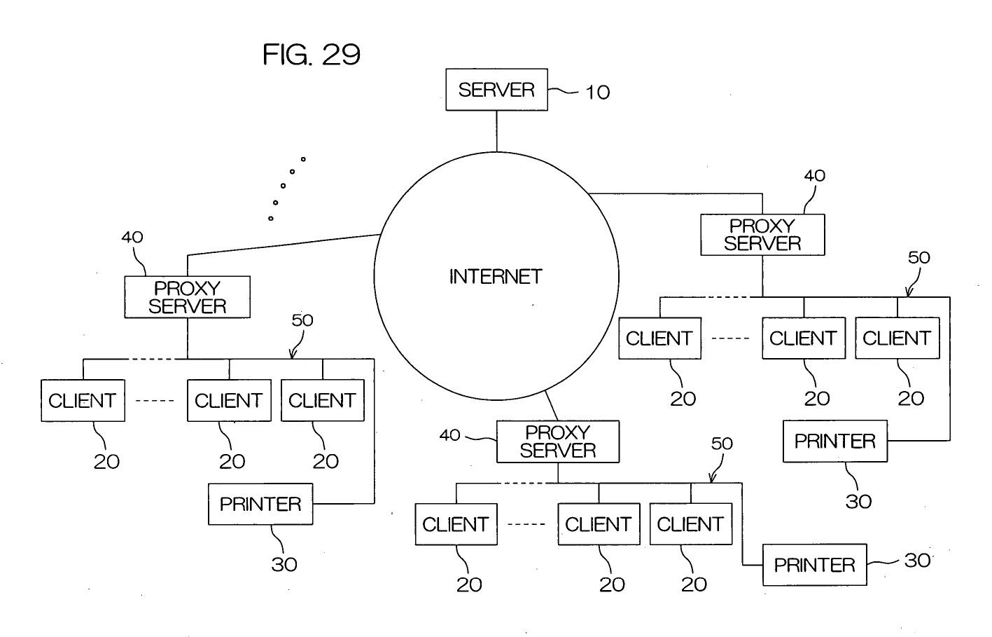

FIG. 29 is a block diagram showing the overall constitution of the electronic voucher system according to another embodiment of the present invention. In this embodiment, the server 10 and a plurality of proxy servers 40 are connected to the Internet. The server 10 is a computer which is capable of processing a large volume of data and is connected to the Internet so as to carry out communications. The proxy servers 40 are personal computers having storage means and are installed, for example, in each office or building.

Connected to the proxy server 40 is LAN (local area network) 50. The LAN 50 has, for example, a plurality of clients 20 and a printer 30, which are installed in an office, connected thereto. The client 20 is a personal computer installed at an office or the like. The client 20 can exchange data with, and share the printer 30 with other clients 20 which are connected to the LAN 50.

The proxy server 40 can connect the Internet and the LAN 50 so as to communicate through each other. As a result, the server 10 and the clients 20 can exchange data with each other via the proxy server 40.

This embodiment has such a constitution as the components of the XRF file are cached in the proxy server 40, while the client 20 receives from the server 10 only those among the component files of the XRF file which are not cached in the proxy server 40, and generates an XRF file on the client 20 side. This constitution reduces the load on the network. Moreover, since the files are cached in the unit of component data, the cache can be hit as far as a part of the component data matches, for a voucher of different content, as well as in such a case where the client 20 issues a request for a voucher of exactly the same content, with a result of improved efficiency of caching. Thus load on the network can be efficiently reduced.

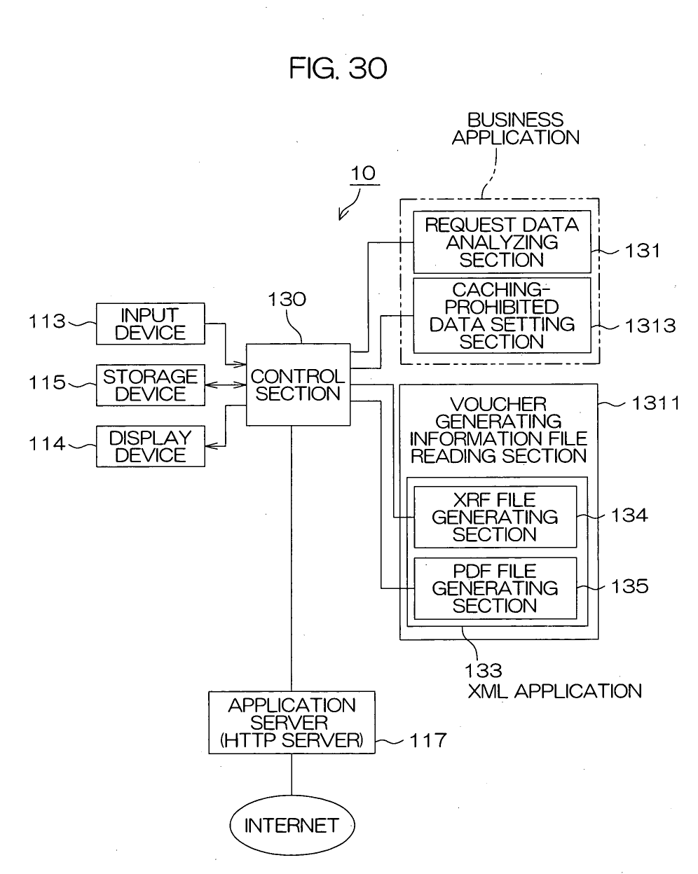

FIG. 30 is a block diagram explanatory of an example of the constitution of a server 10 according to this embodiment. In the block diagram of FIG. 30, components equivalent to those shown in FIG. 4 are assigned with reference numerals identical to those of FIG. 4 and description thereof will be omitted.

The storage device 115 stores the XML parser, the DOM file or SAX file, and the DTD file. The storage device 115 further stores the XRT file, the field information, part XRT file and external resource file, each in a plurality of kinds. The storage device 115 in this constitution further stores update time information which is matched in one-to-one correspondence with each of the DTD file, the XRT file, the field information, the part XRT file and the external resource file. The update time information is the information that indicates the date and time (date and time of last update) when one the DTD file, the XRT file, the field information, the part XRT file and the external resource file was last stored in the storage device 115.

The administrator of the server 10 can use the drawing application for editing the DTD file 123, the XRT file, the field information, the part XRT file and the external resource file, overwriting an updated file in the storage device 115 and write the file with a different name, as required. At this time, the date and time when the file was last stored in the storage device 115 is written together in the storage device 115 as the update time information for each file.

The business application of the server 10 has the function of the request data analyzing section 131 and the function of a caching-prohibited data setting section 1313 that adds information (flag) indicating whether caching is permitted or not for each component data of the XRF file. The business application operates in linkage with a voucher generating information file reading section 1311 that is constituted from the XML application 133.

The request data analyzing section 131 generates voucher generating information file and user data file according to the voucher data request supplied from the client 20, and supplies the voucher generating information file to the voucher generating information file reading section 1311. This triggers the XML application 133 to start so as to call the XML parser via the DOM file or the SAX file.

The XML application 133, via the XML parser, interprets the voucher generating information file which is written in XML file format and, according to the result of interpretation, is able to read, from the storage device 115, the update time information which is matched in one-to-one correspondence with the information (for example, path and file name) that is used to identify the DTD file, the XRT file, the field information, the part XRT file and the external resource file which constitute the XRF file that corresponds to the voucher data.

Then the XML application 133 generates voucher generating information file with the description of update time information added thereto, by combining the component file identifying information (for example, path, file name and of voucher form data identifying information) of the XRF file (voucher data) described in the voucher generating information file and the update time information of each of the files. The XML application 133 submits the voucher generating information file having the update time information added thereto to the request data analyzing section 131. The request data analyzing section 131 can send the voucher generating information file along with the user data file to the client 20 via the application server 117.

When the application server 117 accepts a request of the client 20 to send the component files of the XRF file, the request data analyzing section 131 can read the requested file (the DTD file, the XRT file, the field information, the part XRT file or the external resource file) from the storage device 115, and can send the files which have been read to the client 20 via the application server 117.

When the requested files are sent to the client 20, the requested files (the DTD file, the XRT file, the field information, the part XRT file or the external resource file) are stored (cached) in the proxy server 40. The cached files have the update time information as the attribute thereof.

Such a voucher that includes the company seal or the like can be used illegally, when cached on the client side. To avoid such a problem, caching prohibit information is added to the voucher generating information file for important vouchers and such vouchers that include the company seal or other important image, so that at least the file that constitutes the important portion cannot be cached.

Specifically, the caching-prohibited data setting section 1313 provides the voucher generating information file having such a parameter being embedded therein that prohibits caching of the whole or a part of the component files (the DTD file, the XRT file, the field information, the part XRT file or the external resource file, namely the component files of the voucher form) of the voucher data, in case the voucher data that corresponds to the voucher data request supplied from the client 20 includes a file subjected to caching prohibit setting by the caching-prohibited data setting section 1313. This enables it to impose a limitation to the XRT file, the field information, the part XRT file or the external resource file that would be cached in the proxy server 40.

An example of the format is shown below for the voucher generating information file that includes a parameter for setting prohibition of caching.

```
<?XML version=“1.0”?>
<DOCUMENTINFO>
    <!-parameter information-->
<PARAMETER>
        <OUTPUTMODE>XRF or PDF</OUTPUTMODE>
        <FSETNAME>Accessor setting file</FSETNAME>
        <FORMNAME>voucher file name</FORMNAME>
        <CACHEMODE>caching permitted or not</CACHEMODE>
        <COPIES>number of copies</COPIES>
        <FEEDER>feeder tray</FEEDER>
        <OUTPRINTER>output printer</OUTPRINTER>
                . . . . .
        <REQUESTNAME>user name during log
            output</REQUESTNAME>
            <USERNAME>user name for security</USERNAME>
        <PASSWORD>password for security</PASSWORD>
</PARAMETER>
  <XRT>
    <XRTFILE>specify XRT file name</XRTFILE>
        <XMLDATA>
            <XMLFILE>XML file name</XMLFILE>
</XRT>
```

User data is usually different from voucher to voucher, and therefore needs not be cached. For a user data file, therefore, a parameter that prohibits caching may be added in the voucher generating information file, or the user data may be omitted from those subjected to caching by the operation of an application on the client 20 side.

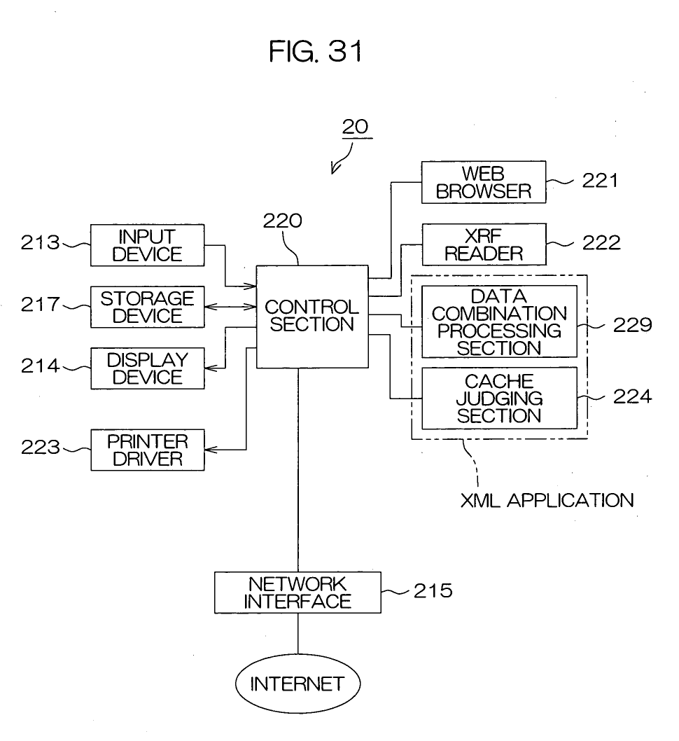

FIG. 31 is a block diagram explanatory of an example of the constitution of the client 20 in the electronic voucher system of this embodiment. In FIG. 31, components equivalent to those shown in FIG. 6 are assigned with reference numerals identical to those of FIG. 6 and description thereof will be omitted.

The client 20 is provided with a data combination processing section 229 and a cache judging section 224. The data combination processing section 229 and the cache judging section 224 are controlled by the control section 220.

The data combination processing section 229 and the cache judging section 224 are function processing sections which are realized by the XML application. Among these, the data combination processing section 229 interprets the voucher generating information file provided from the server 10 and combines the DTD file, the XRT file, the field information, the part XRT file, the external resource file and the user data thereby to generate an XRF file which is a voucher data file.

The cache judging section 224 judges whether there are stored in the proxy server 40, the DTD file, the XRT file, the field information, the part XRT file and the external resource file which are described in the voucher generating information file supplied from the server 10, namely the component files (other than user data) that constitute the XRF file as the voucher data. When it is determined that the XRT file, the field information, the part XRT file and the image file that are identified by the voucher generating information file are not stored in the proxy server 40, the cache judging section 224 sends a request to send absent file that identifies the absent file, to the server 10.

When it is determined that the XRT file, the field information, the part XRT file and the external resource file that are identified by the voucher generating information file are stored in the proxy server 40, the cache judging section 224 checks to see whether the update time information of the files described in the voucher generating information file and the update time information of the corresponding files stored in the proxy server 40 agree with each other or not. When it is determined that the update time information of the files described in the voucher generating information file and the update time information of the corresponding files stored in the proxy server 40 do not agree with each other in one of the component files, the cache judging section 224 sends a request to send absent file that identifies the absent file, to the server 10 via the Web browser 221.

When sending a request to send the absent file, the cache judging section 224 checks to see whether there is a parameter that prohibits caching in the voucher generating information file and, if there is a parameter that prohibits caching described therein, restricts caching in the proxy server 40 by the setting of the HTTP protocol when sending the request to send the absent file from the Web browser 221.

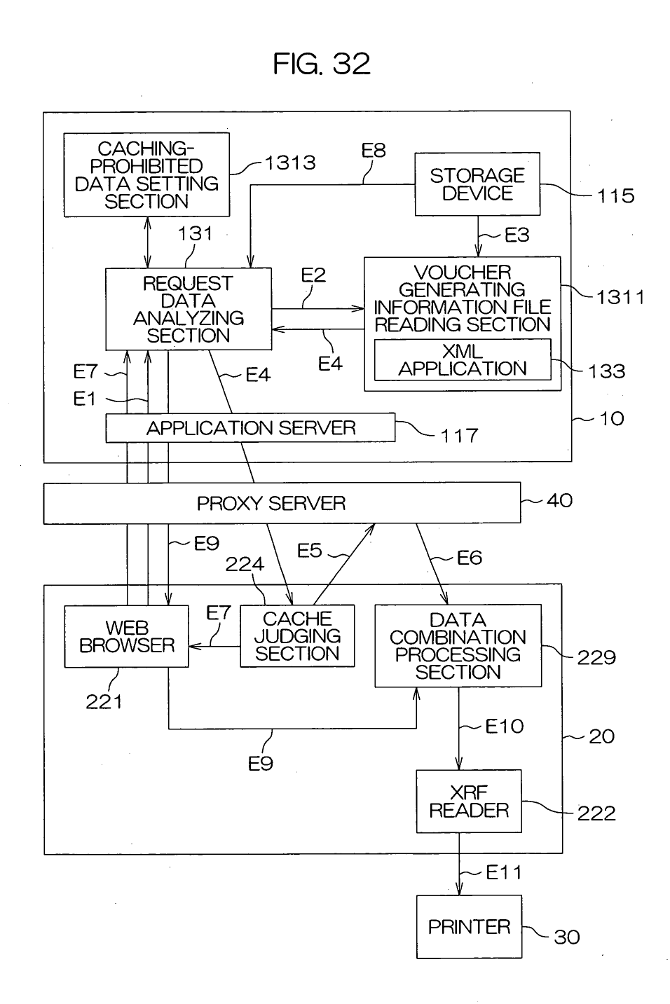

FIG. 32 is a block diagram explanatory of the operation of the electronic voucher system constituted from the server 10 shown in FIG. 30 and the client 20 shown in FIG. 31. When a user of the client 20 operates the input device 213 to enter necessary information to the Web browser 221, voucher data request corresponding to the entered data is sent from the Web browser 221 via the application server 117 to the request data analyzing section 131 (arrow E1).

The request data analyzing section 131 generates a voucher generating information file according to the voucher data request which is received from the Web browser 221. The request data analyzing section 131 also identifies the user data stored in the server 10 according to the portion of data of the voucher data request specified by the user, thereby to generate a user data file. Then the request data analyzing section 131 supplies the voucher generating information file and the user data file to the voucher generating information file reading section 1311 (arrow E2). If the voucher data corresponding to the voucher data request includes component data for which prohibition of caching is set, a parameter that prohibits caching is written in the voucher generating information file by the caching-prohibited data setting section 1313.

When the voucher generating information file 140 and the user data file 151 are supplied to the voucher generating information file reading section 1311, the XML parser and the DOM file or SAX file are read from the storage device 115, and the XML application 133 is started to run. According to the voucher generating information file, the XML application 133 reads the file name of the component file of the XRT file that corresponds to the voucher data request and the update time information of the file from the storage device 115 (arrow E3), generates voucher generating information file with update time information added thereto and sends it from the application server 117 to the cache judging section 224 of the client 20 (arrow E4). At this time, the user data file is sent as well.

The cache judging section 224 which has received the voucher generating information file identifies the file which is described in the voucher generating information file among the component files (the DTD file, the XRT file, the field information, the part XRT file or the external resource file) stored in the proxy server 40. Further, the cache judging section 224 identifies the component file for which the update time information of the corresponding files stored in the proxy server 40 and the update time information of the files described in the voucher generating information file agree with each other, and send to the proxy server 40 a request to send the file (arrow E5). In response to this, the proxy server 40 sends the component file requested by the cache judging section 224 to the data combination processing section 229 of the client 20 (arrow E6).

The cache judging section 224 also sends a request to send absent file that identifies the component file which has not been provided by the proxy server 40 among the component files (the DTD file, the XRT file, the field information, the part XRT file and the external resource file) indicated in the voucher generating information file to the request data analyzing section 131 via the Web browser 221 and the application server 117 (arrow E7). At this time, whether the file may be cached or not in the proxy server 40 is set by the HTTP protocol according to the parameter added to the voucher generating information file.

The request data analyzing section 131 that has received a request to send absent file reads the component files (the DTD file, the XRT file, the field information, the part XRT file or the external resource file) which corresponds to the request for absent file, from the storage device 115 (arrow E8). Then the request data analyzing section 131 sends the component file, which has been read, from the application server 117 via the proxy server 40 and the Web browser 221 to the data combination processing section 229 (arrow E9). In case caching is prohibited by the HTTP protocol used when sending the request to send absent file from the Web browser 221, the component file which has been sent from the server 10 is not cached in the proxy server 40. If caching is not prohibited, the component file sent from the server 10 is cached in the proxy server 40.

The component file cached in the proxy server 40 (the XRT file, the DTD file, the field information, the part XRT file or the external resource file) can be used in common by all the clients 20 that are connected to the proxy server 40. As a result, the component files (the XRT file, the DTD file, the field information, the part XRT file or the external resource file) used in the entire electronic voucher system can be distributed efficiently among the clients 20.

The data combination processing section 229 generates XRF file as the voucher data by combining the component files (the XRT file, the DTD file, the field information, the part XRT file and the external resource file) supplied from the server 10 and from the proxy server 40, with the user data file. More specifically, the data combination processing section 229 acquires the XRT file described in the voucher generating information file, combines the XRT file with part XRT file, image data and the like and combines the user data that corresponds to each field, thereby to generate the XRF file.

The XRF file thus generated is supplied to the XRF reader 222 (arrow E10). The XRF reader 222 which has received the XRF file generates an image of the voucher by developing the XRF file into image data, and displays the image. When a predetermined operation to direct printing is made on the input device 213 while the voucher image is being displayed, print data corresponding to the voucher image is generated and is sent via the printer driver 223 to the printer 30 (arrow E11). Thus a sheet of paper carrying the voucher image is output from the printer 30.

Instead of sending the voucher generating information file and the user data from the server 10 to the client 20, an XRF file without real data may be sent. That is, while an ordinary XRF file has real data such as an XRT file which is a form file, a part XRT file which is linked to the former, an external resource file and user data, an XRF file without real data may be used instead of the voucher generating information file. In this case, of course, the XRF file has the file name of the component file, date and time of updating information of each of the files and, as required, parameter that prohibits caching, described therein.

Caching of the component data of the XRF file may also be done in the client 20. For example, a cache area may be secured in the storage device 217 of the client 20 so as to cache the component file of the voucher data (XRF file) using the cache area as the means of caching. In this case, whether to cache or not is determined through an internal process in the client 20 according to the parameter which sets prohibition of caching in the voucher generating information file. Since user data usually needs not caching, caching of user data may be disabled by the setting of application on the client 20 side.

Since the proxy server has a larger storage capacity, more cache data can be stored therein resulting in higher caching efficiency. Also because a plurality of clients 20 share the common cache area, efficiency of caching is improved compared to the case of caching in the individual clients 20.

In case data to be cached is acquired from the Web browser using HTTP protocol when the proxy server is used, the acquired data is automatically cached in the proxy server, although HTTP protocol may be used to make such a setting that caching is not done in the proxy server.

12. Alteration of Property of Drawing Object at Client

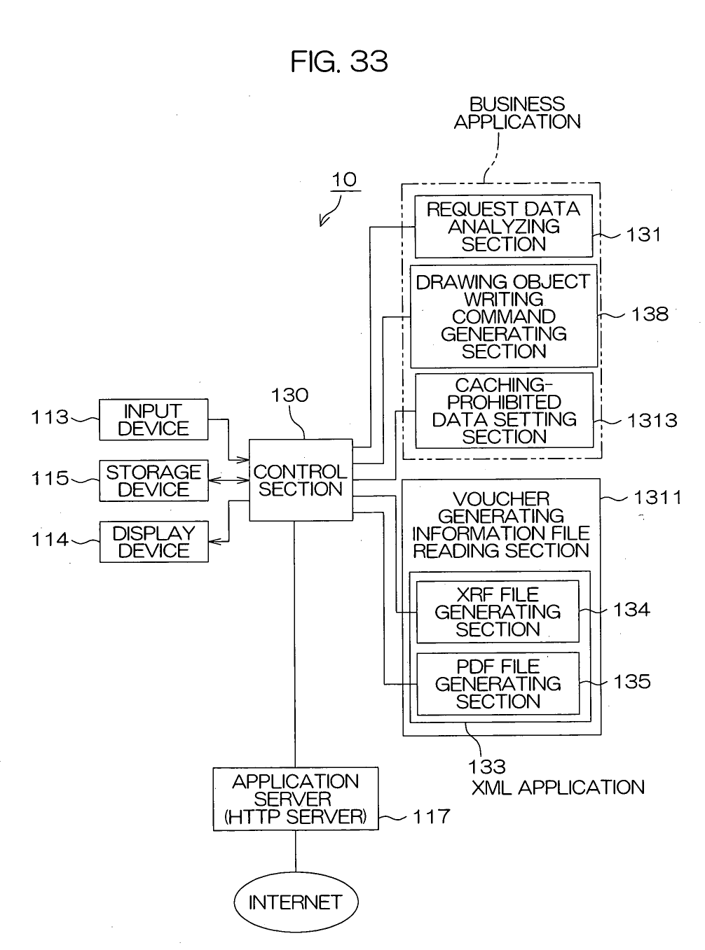

FIG. 33 is a block diagram explanatory of an example of the another constitution of the server 10 used in the electronic voucher system of the constitution shown in FIG. 29. In FIG. 33, components equivalent to those shown in FIG. 30 are assigned with reference numerals identical to those of FIG. 30 and description thereof will be omitted. Since the constitution on the side of client 20 is similar to that of FIG. 31, the following description will also refer to FIG. 31.

In this embodiment, the operation of embedding a drawing object, which has the property which matches the user data, in the voucher form is carried out in the client 20, and an XRF file that is voucher data having the drawing object embedded therein is generated in the client 20.

The business application on the server 10 side has, in addition to the function of the request data analyzing section 131, the function of a drawing object writing command generating section 138 which writes such a command (drawing object writing command) in the voucher generating information file that causes a drawing object having the property which matches the user data identified by the voucher data request, that has been sent from the client 20, to be written in the XRT file at a specified position thereof.

On the client 20 side, on the other hand, the drawing object writing command included in the voucher generating information file is interpreted and executed by the data combination processing section 229 that is constituted from the XML application. As a result, properties (location, shape, size, etc.) of the drawing object specified by the command are written in the XRT file. In other words, the data combination processing section 229 has the function of interpreting the drawing object writing command and writing the drawing object in the XRT file.

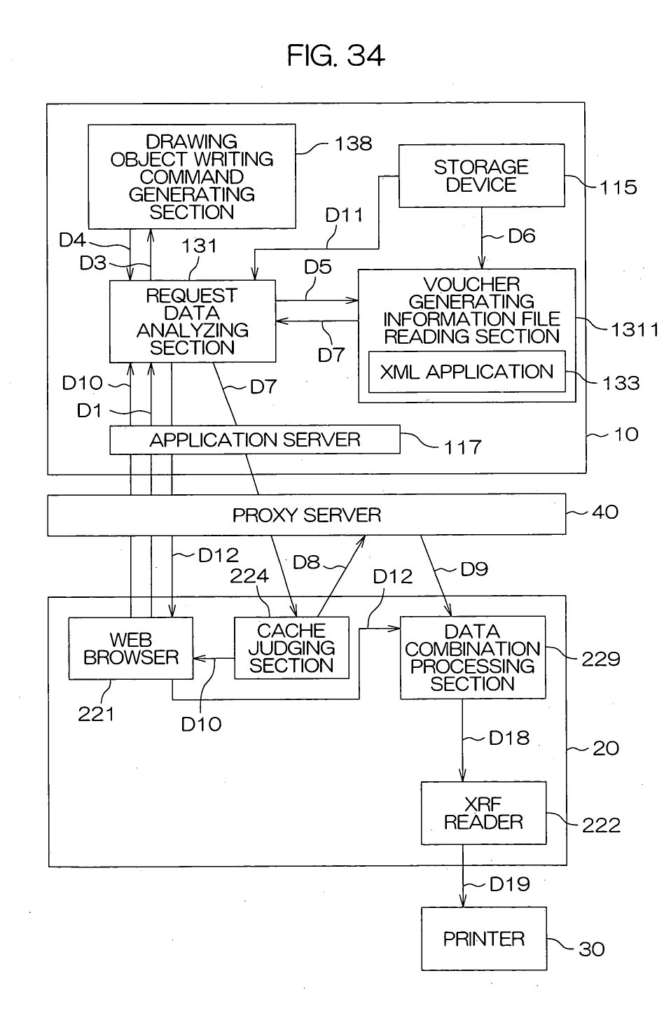

FIG. 34 is a block diagram explanatory of the constitution of the electronic voucher system constituted from the server 10 shown in FIG. 33 and the clients 20 shown in FIG. 31. When a user of the client 20 operates the input device 213 to enter necessary information to the Web browser 221, voucher data request corresponding to the entry is sent from the Web browser 221 via the application server 117 to the request data analyzing section 131 (arrow D1).

The request data analyzing section 131 generates a voucher generating information file according to the voucher data request which is received from the Web browser 221. The request data analyzing section 131 also reads the user data identified by the voucher data request from the storage device 115 and generates a user data file.

In case the voucher form (XRT file) that corresponds to the voucher data request is a voucher form in which a drawing object having the property which matches the user data should be embedded therein, the drawing object writing command generating section 138 acquires the user data from the request data analyzing section 131 (arrow D3), and writes such a drawing object writing command in the voucher generating information file that instructs to embed the drawing object, that has the property which matches the user data, in the voucher form by specifying the position therein (arrow D4).

In case voucher data that corresponds to the voucher data request includes component data for which prohibition of caching is set, the caching-prohibited data setting section 1313 (not shown in FIG. 34) provides the voucher generating information file with such a parameter written therein that prohibits caching.

The request data analyzing section 131 provides the voucher generating information file reading section 1311 with voucher generating information file that includes drawing object writing command and various parameters and user data file (arrow D5).

When the voucher generating information file and the user data file are supplied to the voucher generating information file reading section 1311, XML parser and DOM file or SAX file are read from the storage device 115 and the XML application is started. According to the voucher generating information file 140, the XML application 133 reads the file name of the component file of the XRT file that corresponds to the voucher data request and the update time information of the file from the storage device 115 (arrow D6), generates voucher generating information file with update time information added thereto and sends it from the application server 117 to the cache judging section 224 of the client 20 (arrow D7). At this time, the user data file is sent to the client 20 and supplied to the data combination processing section 229 as well.

The cache judging section 224 which has received the voucher generating information file identifies the file which is described in the voucher generating information file among the component files (the XRT file, the DTD file, the field information, the part XRT file or the external resource file) stored in the proxy server 40. Further, the cache judging section 224 identifies the component file for which the update time information of the component files stored in the proxy server 40 and the update time information of the component file described in the voucher generating information file agree with each other, and sends a request to send the file (arrow D8). In response to this, the proxy server 40 sends the component file requested by the cache judging section 224 to the data combination processing section 229 of the client 20 (arrow D9).

The cache judging section 224 also sends a request to send absent file that identifies the component file which has not been provided by the proxy server 40 among the component files (the XRT file, the DTD file, the field information, the part XRT file and the external resource file) indicated in the voucher generating information file, to the request data analyzing section 131 via the Web browser 221 and the application server 117 (arrow D10). At this time, whether the file may be cached or not in the proxy server 40 is set by the HTTP protocol for each component file.

The request data analyzing section 131 that has received a request to send absent file reads the component file (the XRT file, the DTD file, the field information, the part XRT file or the external resource file) which corresponds to the request for absent file, from the storage device 115 (arrow D11). Then the request data analyzing section 131 sends the component file, which has been read, from the application server 117 via the proxy server 40 and the Web browser 221 to the data combination processing section 229 (arrow D12). In case caching is prohibited by the HTTP protocol used when sending the request to send absent file from the Web browser 221, the component file sent from the server 10 is not cached in the proxy server 40. If caching is not prohibited, the component file sent from the server 10 is cached in the proxy server 40.

The data combination processing section 229 generates an XRF file as voucher data by combining the component files (the XRT file, the DTD file, the field information, the part XRT file or the external resource file) supplied from the server 10 and from the proxy server 40, with the user data file, and writing a new drawing object in the XRT file according to the drawing object writing command included in the voucher generating information file.

The XRF file thus generated is supplied to the XRF reader 222 (arrow D18). The XRF reader 222 which has received the XRF file generates an image of the voucher by developing the XRF file into image data, and displays the image. When a predetermined operation to direct printing is made on the input device 213 while the voucher image is being displayed, print data corresponding to the voucher image is generated and is sent via the printer driver 223 to the printer 30 (arrow D19). Thus a sheet of paper carrying the voucher image is output from the printer 30. With these operations, voucher which has the drawing object of the property (particularly the shape) that corresponds to the user data embedded therein can be obtained.

On the side of the client 20, since the XML application carries out the operation to generate a new drawing object according to the command included in the voucher generating information file, instead of carrying out the operation to change the property of an existing drawing object, business logic is not required. As a result, it is made easier to maintain and manage the programs at a plurality of clients 20.

In addition, load on the network can be significantly reduced because of such a constitution as the proxy server 40 is used for caching and component data of the XRF file is acquired from the proxy server 40 so as to generate the XRF file at the client 20.

In this example of constitution, too, an XRF file without real data may be sent instead of sending the voucher generating information file from the server 10 to the client 20.

Caching of the component data of the XRF file may also be carried out in the client 20.

### 13. Embodiment Capable of Certifying Users

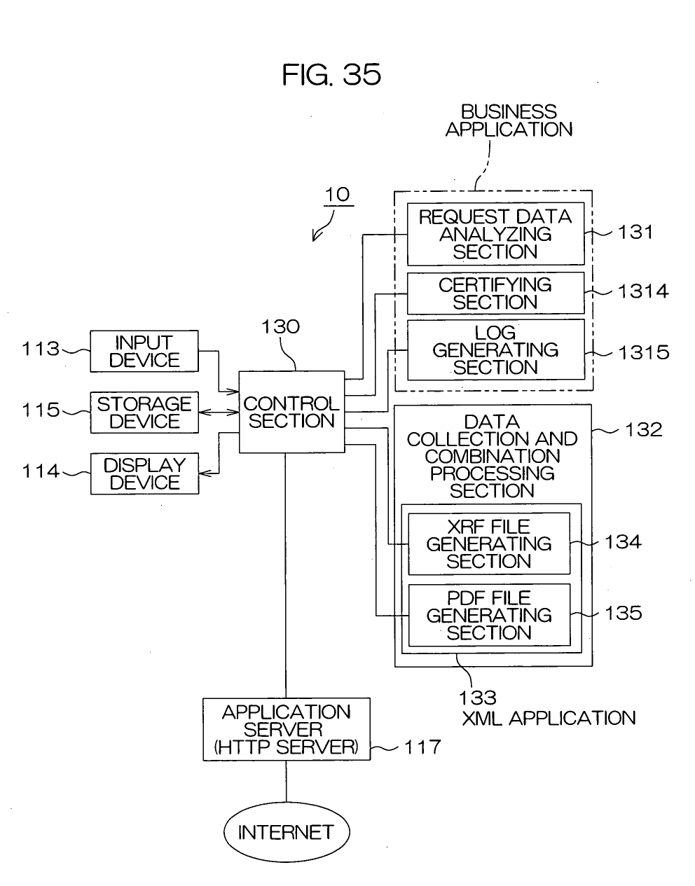

FIG. 35 is a block diagram explanatory of an example of constitution of the server 10 according to further another embodiment of the invention. In FIG. 35, components equivalent to those shown in FIG. 4 are assigned with reference numerals identical to those of FIG. 4 and description thereof will be omitted.

The electronic voucher system of this embodiment has an overall constitution similar to that shown in FIG. 29. In the electronic voucher system of this embodiment; however, it is made possible to restrict the request for voucher data and output of voucher except for particular terminals, by setting client terminals which are permitted to make request for voucher data and output of voucher in advance and certifying the clients.

The server 10 is provided with a certifying section 1314 as a function processing section of the business application and a log generating section 1315 which are controlled by a control section 130.

The certifying section 1314 makes reference to the user name and the password of the administrator of the client 20 which have been stored in the storage device 115 in advance. When the user name and the password of the administrator of the client 20 are provided from the client 20 to the server 10 during the connection via the Internet between the client 20 and the server 10 is established, the certifying section 1314 judges whether or not the user name and the password provided by the client 20 agree with the user name and the password which are stored in the storage device 115. If it is confirmed that they agree, the administrator of the client 20 can set the voucher for permitting the client 20 to provide voucher by making a predetermined operation on the input device 213. Thus particular clients 20 can be designated as terminals permitted to get the output of particular voucher.

When such a setting operation is carried out, the certifying section 1314 sends a Cookie, which is information that permits it to send the voucher data, to the client 20. When the Cookie is sent from the server 10 to the client 20, it is stored in the storage device 217 of the client 20. When a client 20 which has received the Cookie is connected again via the Internet with the server 10 that sent the Cookie, the client 20 gives the Cookie to the server 10.

When a user connects to the server 10 by using the client 20 that has Cookie that represents permission to send voucher data, the Cookie is sent via the application server 117 to the certifying section 1314. The certifying section 1314 then provides the permitted voucher data to the client 20 and restricts other voucher data from being sent, according to the content of the Cookie which has been sent from the client 20.

There may be such a case as the user name and password of the administrator of the client 20 are provided from the client 20 to the server 10 during the connection is established via the Internet between the client 20 which has Cookie that represents permission to send voucher data and the server 10. In this case, the certifying section 1314 judges whether or not the user name and the password provided by the client 20 agree with the user name and the password stored in the certifying section 1314. When the administrator of the client 20 makes a predetermined operation to cancel the setting on the input device 213 after it is confirmed that they agree, setting of the permission to send voucher data which has been granted to the client 20 can be canceled. When the setting of permission to send is canceled, the certifying section 1314 can send Cookie, of which setting of permission to send voucher data is canceled, to the client 20.

When a user connects to the server 10 by using the client 20 which has Cookie, of which setting of permission to send voucher data has been canceled (that is, permission to send is not set) or which does not have such Cookie, the Cookie of which setting of permission to send voucher data is canceled is sent via the application server 117 to the certifying section 1314 (or Cookie is not given). The certifying section 1314 which has received the Cookie without the setting of permission to send voucher data (or which has not received Cookie) prohibits it to send the requested voucher data to the client 20.

The log generating section 1315 can store, in the storage device 115, the information on the time (date and time) when the XRF file or PDF file generated by the XML application 133 were sent to the client 20. That is, transmission record (log) can be generated for the voucher data file sent from the server 10 to the client 20.

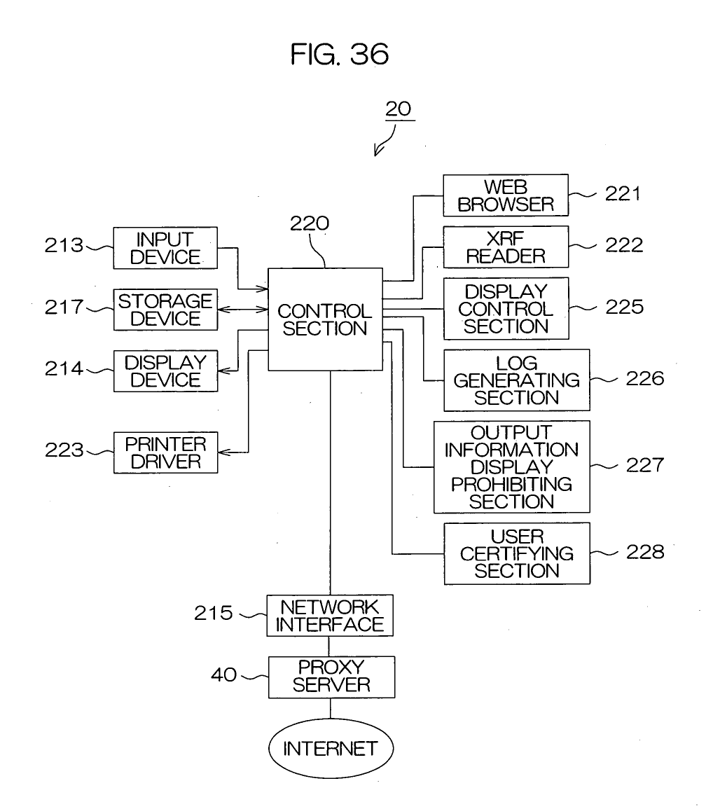

FIG. 36 is a block diagram explanatory of an example of the constitution of the client 20 according to this embodiment. In FIG. 36, components equivalent to those shown in FIG. 6 are assigned with reference numerals identical to those of FIG. 6 and description thereof will be omitted.

In this constitution, the client 20 is provided with the storage device 217. The storage device 217 can store the Cookie given to the control section 220 by a server (including the server 10). When connection with a server (including the server 10) from which Cookie was previously given is established again, the control section 220 reads the Cookie, that was given from the server previously, from the storage device 217 and sends it to the server.

The client 20 is provided also with a display control section 225, a log generating section 226, an output information display prohibiting section 227 and a user certifying section 228, which are controlled by the control section 220.

The display control section 225 fixes the screen of the display device 214 to system modal screen and disables operation signals from the input device 213 to the control section 230 during a period from the time when voucher data request is sent to the server 10 and printing of voucher is commanded till the time when printing of the voucher image that corresponds to the voucher data request by the printer 30 is completed.

The log generating section 226 can store such a log (record of voucher output) in the storage device 217, that includes the information on the time (date and time) when the voucher data request was sent from the client 20 to the server 10, the information on the time (date and time) when the XRF file or PDF file was received from the server 10, the information on the time (date and time) when the print data was sent to the printer 30, the information on the time (date and time) when the end of print signal, that indicates completion of printing, was received from the printer 30 and the information on the kind of voucher. The administrator of the client 20 can view the log stored in the storage device 217 by making a predetermined operation on the input device 213.

The output information display prohibiting section 227 controls to prohibit the display of voucher image in accordance with the parameter setting in the XRF file.

User name and password of the client 20 are stored in the storage device 217 and controlled by the user certifying section 228. User name and password entered through the input device 213 are checked to see whether they agree with the user name and the password stored in the storage device 217. The user cannot get output of voucher by using the client 20 unless the user name and the password which have been entered through the input device 213 are verified to agree with the user name and the password stored in the storage device 217.

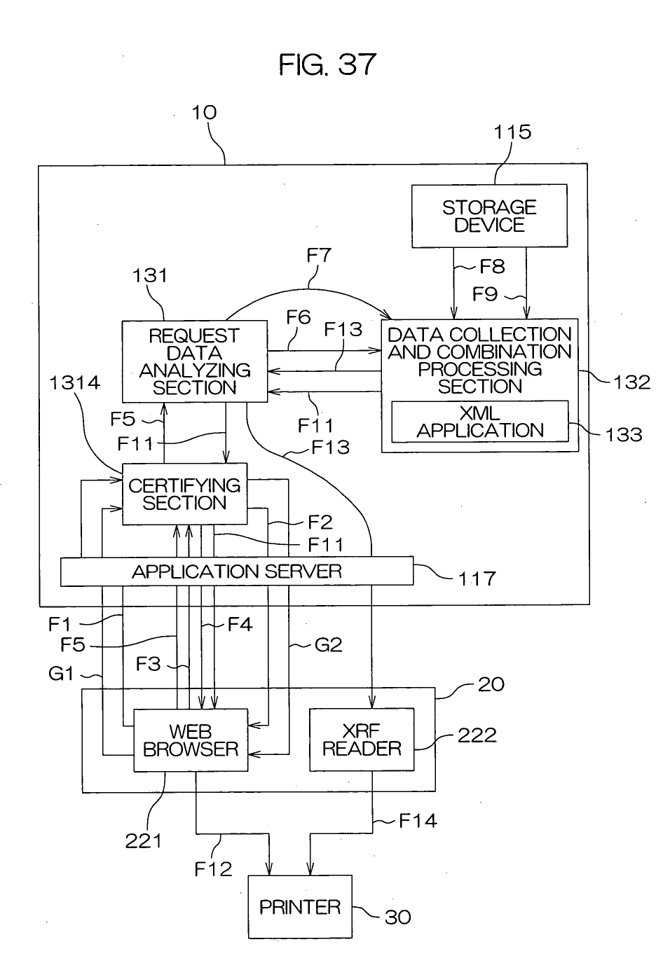

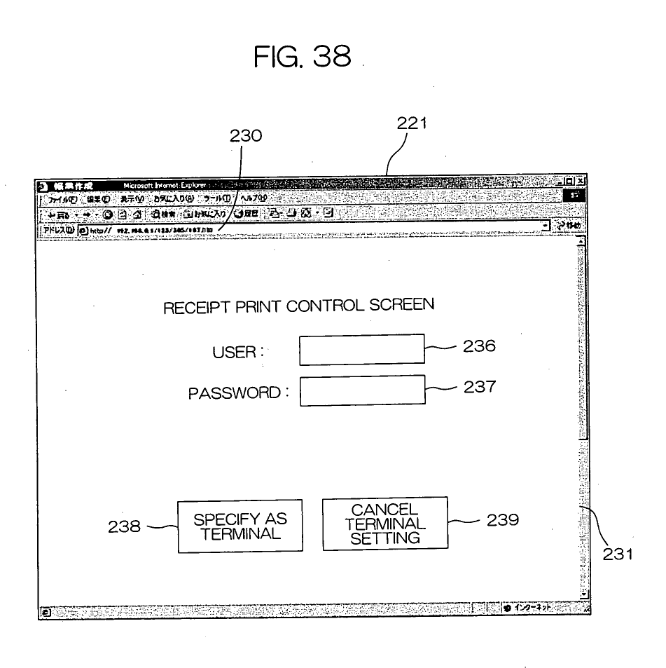

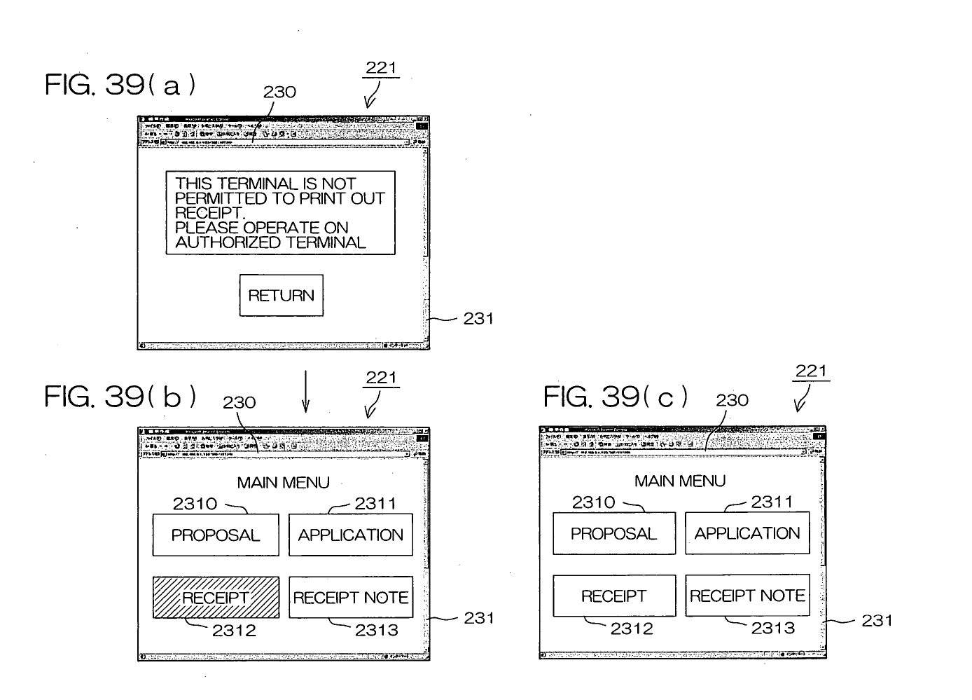

FIG. 37 is a block diagram explanatory of schematic constitution of the electronic voucher system constituted from the server 10 shown in FIG. 35 and the clients 20 shown in FIG. 36. FIG. 38 shows an example, as displayed by the Web browser 221, of an acceptance screen that receives the entry of setting for permission to send voucher data. FIGS. 39(a), 39(b) and 39(c) show examples, as displayed by the Web browser 221, of an acceptance screen (menu screen) that receives the entry of voucher data request.

The administrator of the client 20 can have such a screen as shown in FIG. 38 displayed on the display section 231 of the Web browser 221, by entering the URL of the server 10 in the URL input section of the Web browser 221 and making a predetermined operation on the input device 213, thereby receiving HTML file or the like from the application server 117. FIG. 38 shows the acceptance screen that receives the entry of the setting for permission to send voucher data of a receipt to be supplied from the server 10 to the client 20. Displayed at the center of the display section are a user name input section 236 for entering the user name of the administrator of the client 20, and a password input section 237 for entering the password of the administrator of the client 20. Displayed below the user name input section 236 and the password input section 237 are a SPECIFY AS TERMINAL button 238 and a CANCEL TERMINAL SETTING button 239. In the acceptance screen a pointer (not shown) is displayed for the Web browser 221, so that the user can operate the input device 213 (manly a pointing device) to move the pointer to the button 238 or the button 239 and press (click) the button 238 or the button 239.

When the user name of the administrator of the client 20 is entered in the user name input section 236 and the password of the administrator of the client 20 is entered in the password input section 237 and the SPECIFY AS TERMINAL button 238 is pressed (arrow F1), then the certifying section 1314 carries out certifying operation and, on condition that the user name and the password agree with those registered beforehand, sends the Cookie (including registered ID as the terminal identifying information) that represents permission of sending the voucher data of the receipt to the client 20 (arrow F2). Then the client 20 stores the Cookie in the storage device 217. This causes the client 20 to be set as a terminal which can receive voucher data of a receipt. Certification of the user may be carried out by means of biometric certification using finger print or palm print, or ID card.

When the Cookie that represents permission of sending the voucher data of receipt is stored in the storage device 217 of the client 20, if the user name of the administrator of the client 20 is entered in the user name input section 236 and the password of the administrator of the client 20 is entered in the password input section 237 by the client 20 and the CANCEL TERMINAL SETTING button 239 is pressed (arrow G1), then the certifying section 1314 carries out certifying operation and, on condition that the user name and the password agree with those registered beforehand, the Cookie which indicates that the permission of sending the voucher data of receipt is canceled is sent to the client 20 (arrow G2). Then the client 20 stores the Cookie in the storage device 217. This causes the client 20 to be set as a terminal which can not receive voucher data of a receipt.

When the user enters the URL of the server 10 in the URL input section 230 of the Web browser 221, all Cookies stored in the storage device 217 are sent to the certifying section 1314 (arrow F3). The certifying section 1314 selects the file described in HTML or the like according to the Cookie supplied from the client 20. Then the application server 117 sends the file described in HTML or the like to the client 20 (arrow F4). As a result, the display device 214 of the client 20 displays different screens according to the Cookie supplied from the client 20 to the server 10.

When the client 20 which has no Cookie supplied from the server 10 or the client 20 having Cookie which shows no permission of sending the voucher data of receipt being stored in the storage device 217 thereof is connected to the server 10 via the Internet, the display section 231 of the Web browser 221 of the client 20 displays such a screen as shown in FIG. 39(a). In the screen shown in FIG. 39(a), it is described that the voucher data of a receipt cannot be provided to the client 20. Thereafter, the display section 231 of the Web browser 221 of the client 20 displays such a screen as shown in FIG. 39(b).

FIG. 39(b) shows an example of main menu screen where types of voucher can be selected. In this example, the display section 231 of the Web browser 221 shows a PROPOSAL button 2310, an APPLICATION button 2311, a VOUCHER OF RECEIPT button 2312 and a RECEIPT NOTE 2313 displayed therein. The VOUCHER OF RECEIPT button 2312 is displayed in gray (state of display indicating the button is inoperable, shown in the drawing by shading), and cannot be operated. Thus the user cannot enter the Web page which is linked to the VOUCHER OF RECEIPT button 2312, and is disabled to send voucher data request for receipt to the server 10. Instead of making The VOUCHER OF RECEIPT button 2312 inoperable, HTML file or the like that causes a screen indicating the terminal is unable to print vouchers of receipt may be sent from the server 10 when the VOUCHER OF RECEIPT button 2312 is operated at a terminal which is not certified.

When the URL of the server 10 is entered in the URL input section 230 of the Web browser 221 of client 20 which has Cookie having permission to send voucher data being set, a screen as shown in FIG. 39(c) is displayed. In the screen shown in FIG. 39(c), the PROPOSAL button 2310, the APPLICATION button 2311, the VOUCHER OF RECEIPT button 2312 and the RECEIPT NOTE button 2313 are displayed. All of these buttons are operable, and the user can send to the server 10 a request for any of the voucher data (proposal document, application form, receipt and receipt note) which can be provided by the server 10.

There may be cases where the voucher data request is restricted depending on the content of the Cookie sent from the client 20 to the server 10. The user can send request to send voucher data to the request data analyzing section 131 under this restriction (arrow F5 in FIG. 37).

When voucher data request is given to the request data analyzing section 131, the request data analyzing section 131 generates a voucher generating information file that describes, in XML, the information (command and parameters) for generating the voucher data that corresponds to the voucher data request. The request data analyzing section 131 also generates a user data file by reading the user data that corresponds to the voucher data request from the storage device 115.

The voucher generating information file and user data file generated by the request data analyzing section 131 are sent to the data collection and combination processing section 132 (arrows F6, F7).

Upon receipt of the voucher generating information file and user data file, the data collection and combination processing section 132 reads the XML parser and DOM file or SAX file from the storage device 115 (arrow F8), thereby to start the XML application 133.

If PDF file format is not specified for the output file mode of voucher data in the output file mode descriptor section of the voucher generating information file, the XRF file generating section 134 of the XML application 133 reads and collects the the XRT file, DTD file, the field information, the part XRT file and the external resource file from the storage device 115 (arrow F9) if necessary according to the voucher generating information file, and combines these files and the user data thereby to generate the XRF file.

The XRF file thus generated is sent from the application server 117 to the client 20 (arrow F13), so as to be processed by the XRF reader 222. The XRF reader 222 generates voucher image from the XRF file, then generates print data that corresponds to the voucher image and sends the print data via the printer driver 223 to the printer 30 (arrow F14).

If PDF file format is specified for the output file mode of voucher data in the output file mode descriptor section 1411 of the voucher generating information file 140, the PDF file generating section 135 of the XML application 133 reads and collects the XRT file, the DTD file, the field information, the part XRT file and the external resource file from the storage device 115 (arrow F9) if necessary according to the voucher generating information file, and combines these files and the user data file thereby to generate the PDF file. The PDF file thus generated is sent via the application server 117 to the Web browser 221 of the client 20 (arrow F11). When the user makes a predetermined operation on the input device 213 while the Web browser 221 is displaying the PDF file which has been received, print data that corresponds to the voucher data in PDF format is generated and is sent via the printer driver 223 to the printer 30 (arrow F12).

When the XRF file or the PDF file is sent from the application server 117 to the client 20, the log generating section 1315 generates a log that indicates that the XRF file or the PDF file has been sent to the client 20 and write the log in the storage device 115. The log includes such information as date and time, job name, voucher number, voucher name, number of voucher sheets and whether certification tracking is necessary or not.

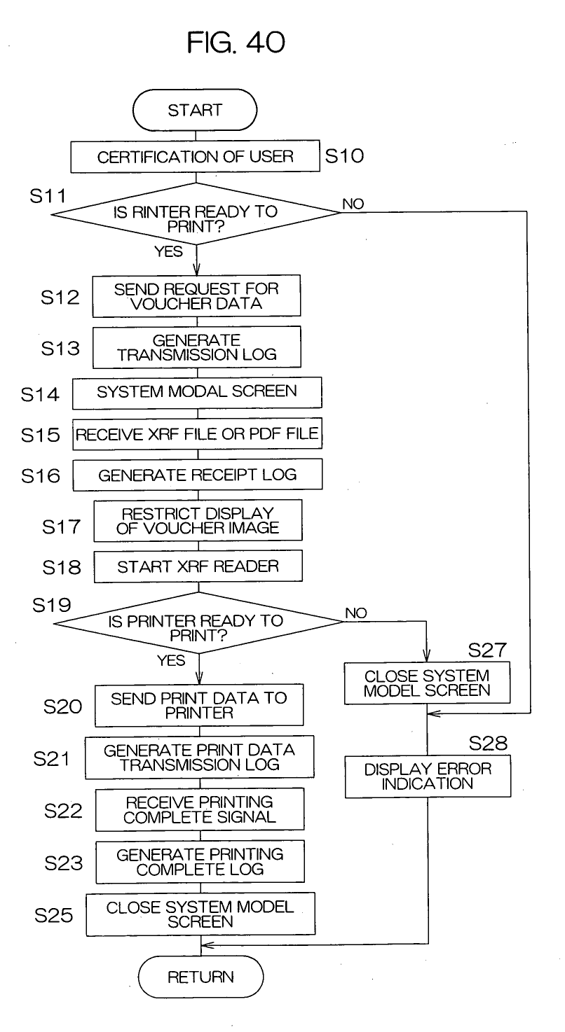

FIG. 40 is a flow chart explanatory of the operation of controlling the client 20. Operation to get output of voucher cannot be done in the client 20 unless the user certifying section 228 confirms that the user name and password provided by the client 20 agree with the user name and the password which are stored in the storage device 217. If the user name and the password provided by the client 20 agree with the user name and the password stored in the storage device 217 (step S10), the control section 220 judges whether the printer 30 is in a state capable of printing or not (step S11). If the printer 30 is not in a state capable of printing (No in step S11), an error indication is given on the display device 214 (step S28) and the operation is forced to end. In this case, the user may wait for the printer 30 to become capable of printing, or contact the administrator to notify the trouble of the printer 30, or cancel the printing of the voucher.

If the printer 30 is in a state capable of printing (Yes in step S11), the user's entry of voucher data request is accepted and the entered voucher data request is sent to the server 10 (step S12). Then the log generating section 226 generates a transmission log and stores it in the storage device 217 (step S13). The transmission log includes such information as date and time when the voucher date request was sent to the server 10, job name, voucher number, voucher name, number of voucher sheets and whether certification tracking is necessary ort not.

Then the output information display setting section 225 fixes the screen of the display device 214 to system modal screen according to the parameter setting in the XRF file (step S14) and enters a state where any input operations cannot be accepted and printing of the voucher cannot be canceled, while printing operation is carried out in the background. The system modal screen may also be the screen in which the user has entered the voucher data request.

As described above, the user cannot operate the client 20 after entering the voucher data request. As a result, it is made impossible to cancel printing while a voucher is being printed and output an unprinted voucher or a voucher which is printed incompletely, thus enabling it to prevent incomplete voucher from being illegally used.

After the voucher data request has been sent to the server 10, the client 20 receives XRF file or PDF file from the server 10 (step S15), so that the log generating section 226 generates a receipt log related to receipt of XRF file or PDF file and stores it in the storage device 217 (step S16). The transmission log includes such information as date and time of receiving, job name, voucher number, voucher name, number of voucher sheets and whether certification tracking is necessary or not.

On the other hand, the output information display prohibiting section 227 prohibits it to display voucher images according to the parameter setting in the XRF file (step S17). This enables it to prevent such illegal operation as copying the image of voucher displayed on the display device 214 so as to make an illegal voucher.

Then the XRF reader 222 is started so that the XRF reader 222 automatically generates the image of voucher from the XRF file (step S18), and the control section 220 judges whether the printer 30 is in a state capable of printing or not (step S19) If the printer 30 is not in a state capable of printing (No in step S19), the system modal screen is put to an end (step S27) and input operation is enabled. Then an error indication is displayed (step S28) and the printing operation is forced to end.

If the printer 30 is in a state capable of printing (Yes in step S19), the XRF reader 222 generates print data that corresponds to the voucher image, and the print data is sent to the printer 30 (step S20). Then the log generating section 226 generates a print data transmission log and stores it in the storage device 217 (step S21). The print data transmission log includes such information as date and time when the transmission of print data was completed (end of data output from spool to printer), job name and result of spool output.

After the print data has been sent to the printer 30 by background operation, the printer 30 sends a printing complete notice, that notifies that the print data has been printed, to the client 20 (step S22).

Then the log generating section 226 generates a printing complete log and stores it in the storage device 217 (step S23), and the system modal screen is put to an end (step S25) and input operation is enabled. The printing complete log includes such information as date and time when the printing complete notice was received, job name, number of printed sheets, tray information, printing paper information and output result.

Since logs are generated in each step of the printing operation, when a trouble occurs during printing, the step in which the trouble occurred can be identified. This enables it to determine whether the printing actually failed or printing was done but the output paper was lost, thus making it possible to effectively prevent illegal use of voucher.

Instead of certifying terminals by using Cookie, such a file that is made to verify terminals that are permitted to print particular vouchers such as receipt may be stored in the storage device 217, so as to certify terminals by checking to see whether the file exists in the terminal by means of applet.

### 14. Other Embodiments

In the embodiments described above, the server 10 and the clients 20 exchange data via the Internet. However, exchange of data may also be carried out by means of an exclusive network owned by an organization such company.

In case many clients 20 are installed in a building or an office, the server 10 may be installed in the building or office and manage the clients 20 installed in the building or the office. In this case, the server 10 and the clients 20 may exchange data via LAN, instead of the Internet.

Furthermore, the constitution may not necessarily such that only one server 10 is provided in the network such as the Internet, but a plurality of servers 10 may be connected to the network.

While the embodiments of the invention have been described and illustrated above, it should be understood that these are exemplary of the invention and are not to be considered as limiting. Accordingly, the invention is not to be considered as limited by the foregoing description but is only limited by the scope of the appended claims.

The present application corresponds to Japanese Patent Application Nos. 2002-378313, 2002-378314, 2002-378318 and 2002-378319 filed in the Patent Office on Dec. 26, 2002, the contents of which are incorporated herein by reference.

1. A business form issuing apparatus comprising:
business form style data storing means which stores business form style data having business form part arranging area being set therein;
business form part storing means which stores parts of business forms of a plurality of kinds that can be arranged in the business form part data arranging area;
business form part reading means which reads out part of business form from among the parts of business forms of a plurality of kinds stored in the business form part storing means in accordance with user data which should be reflected in the business form; and
business form data generating means which generates business form data that includes the business form style data that is read from the business form style data storing means and the part of business form that is read by the business form part reading means, while the parts of business forms are associated with the business form part arranging area of the business form style data.

2. A business form issuing apparatus according to claim 1, wherein the business form part storing means stores a plurality of parts of business forms having different forms.

3. A business form issuing apparatus according to claim 1, wherein the business form issuing apparatus is a server connected to a network and further comprises:
means for receiving business form data request which is sent from a client that is connected to the network;
means for generating user data that corresponds to the business form data request; and
means for sending the business form data via the network to the client.

4. A business form issuing apparatus according to claim 1, further comprising business form data request receiving means which accepts the business form data request,
wherein the business form data generating means includes means for generating business form data of such a configuration that a drawing object, is arranged on the business form style, the drawing object having a property which is made different in accordance with the user data that corresponds to the business form data request accepted by the business form data request receiving means.

5. A business form issuing apparatus according to claim 4, wherein the business form style data storing means stores the business form style data wherein the drawing object is arranged, and
the business form data generating means comprises:
change of property directing means which directs to change the property of the drawing object of the business form style data that corresponds to the business form data request in accordance with the user data that corresponds to the business form data request which is accepted by the business form data request receiving means; and
means for changing the business form style data by reading, from the business form style data storing means, the business form style that corresponds to the business form data request accepted by the business form data request receiving means and changing the property of the drawing object according to the direction by the change of property directing means.

6. A business form issuing apparatus according to claim 4, wherein the business form data generating means generates the business form data of such a configuration that a drawing object is arranged on the business form style, the drawing object having a property related to form which is made different in accordance with the user data that corresponds to the business form data request.

7. A business form issuing apparatus according to claim 1, further comprising business form data request receiving means which accepts the business form data request that specifies the kind of business form,
wherein the business form style data storing means stores business form style data of a plurality of kinds,
the business form part storing means stores parts data which are linked to a business form part arranging area that is set commonly in the business form style data of a plurality of kinds,
the business form data generating means includes means for reading, from the business form style data storing means, the business form style data that corresponds to the business form data request accepted by the business form data request receiving means, reading a part data which is linked to the business form part arranging area that is set in the business form style data from the business form part storing means, and combining these business form style data and part data thereby to generate business form data.

8. A business form issuing apparatus according to claim 7, wherein the business form part storing means stores part form data, as the part data used for the business form style data, having the part arranging area which is linked to the part data being set therein.

9. A business form issuing apparatus according to claim 1, further comprising:
processing means which generates print data by processing the business form data generated by the business form data generating means, and carries out printing process to send the print data to a printing device;
input means for input operation; and
input operation restricting means which restricts the input operation to be made through the input means so that printing process cannot be interrupted while the processing means is processing the printing operation.

10. A business form issuing apparatus according to claim 9, further comprising displaying means for providing operation screen,
wherein the processing means executes the printing operation without displaying the business form image on the displaying means.

11. A business form issuing apparatus according to claim 9, further comprising printing process record generating means which monitors the printing process and generates a printing process record.

12. A business form issuing apparatus according to claim 1, wherein the business form data generating means generates the business form data in the form of business form generating information file which is capable of generating data that can be used for printing a business form by carrying out a predetermined data processing thereto.

13. An electronic business form system which has a business form data server and a client that are connected to a network, wherein the business form data server comprises:
business form style data storing means which stores business form style data having a business form part arranging area being set therein;
business form part storing means which stores parts of business forms of a plurality of kinds that can be arranged in the business form part arranging area;
business form part reading means which reads out part of business form from among the parts of business forms of a plurality of kinds stored in the business form part storing means in accordance with user data which should be reflected in the business form;
business form data generating means which generates business form data that includes the business form style data read from the business form style data storing means and the part of business form read by the business form part reading means, wherein the part of business form is associated with the business form part arranging area of the business form style data;
means for receiving business form data request from the client;
means for generating user data that corresponds to the business form data request; and
means for sending the business form data via the network to the client,
wherein the client comprises:
means for sending the business form data request via the network to the business form data server; and
means for receiving the business form data which is sent from the business form data server via the network.

14. An electronic business form system according to claim 13, wherein the client further comprises:
processing means which generates print data by processing the business form data, and carries out printing process to send the print data to a printing device;
input means for input operation; and
input operation restricting means which restricts the input operation from being made through the input means so that printing process can not be interrupted while the processing means is processing the printing operation,
wherein the processing means processes the printing of business form data which is sent from the business form data server via the network.

15. An electronic business form system according to claim 13, wherein the business form data server further includes a transmission record generating means which generates transmission record when sending the business form data.

16. An electronic business form system according to claim 13, wherein the client includes a certification information recording means which records certifying information that indicates business form issuing terminal, and
the business form data server sends business form data only to a client which has the certification information that indicates business form issuing terminal.
